(19) United States
(12) Patent Application Publication
(10) Pub. No.: US 2015/0043905 A1
(43) Pub. Date: Feb. 12, 2015

(54) System and Method for Photonic Switching and Controlling Photonic Switching in a Data Center

(71) Applicant: FutureWei Technologies, Inc., Plano, TX (US)

(72) Inventors: Alan Frank Graves, Kanata (CA); Peter Ashwood-Smith, Gatineau (CA); Eric Bernier, Ottawa (CA); Dominic Goodwill, Ottawa (CA)

(73) Assignee: FutureWei Technologies, Inc., Plano, TX (US)

(21) Appl. No.: 13/961,663

(22) Filed: Aug. 7, 2013

(51) Int. Cl. H04Q 11/00

(52) U.S. Cl. CPC H04Q 11/0005; H04Q 11/0062; H04Q 2011/0083; H04Q 2011/0037
USPC 398/25; 398/45

(57) ABSTRACT

In one embodiment, data center includes a packet switching core and a photonic switch. The photonic switch includes a first plurality of ports optically coupled to the packet switching core and a second plurality of ports configured to be optically coupled to a plurality of peripherals, where the photonic switch is configured to link packets between the plurality of peripherals and the packet switching core. The data center also includes a photonic switch controller coupled to the photonic switch and an operations and management center coupled between the packet switching core and the photonic switch controller.

### TECHNICAL FIELD

The present invention relates to a system and method for communications, and, in particular, to a system and method for photonic switching in a data center.

### BACKGROUND

Today, data centers may have a very large number of servers. For example, a data center may have more than 50,000 servers. To connect the servers to one another and to the outside world, a data center may include a core switching function and peripheral switching devices.

A large data center may have a very large number of interconnections, which may be implemented as optical signals on optical fibers. These core interconnections connect a large number of peripheral switching devices and the core switching function. The core switching function may be implemented as a small number of very large core electrical switches, which are operated as a distributed core switches. In some data centers, the peripheral switching devices are implemented directly within the servers, and the servers interconnect directly to the core switching function. In other data centers, the servers hang off top of rack (TOR) switches, and the TOR switches are connected to the core switching function by the core interconnections.

### SUMMARY

An embodiment data center includes a packet switching core and a photonic switch. The photonic switch includes a first plurality of ports optically coupled to the packet switching core and a second plurality of ports configured to be optically coupled to a plurality of peripherals, where the photonic switch is configured to link packets between the plurality of peripherals and the packet switching core. The data center also includes a photonic switch controller coupled to the photonic switch and an operations and management center coupled between the packet switching core and the photonic switch controller.

An embodiment method of controlling a photonic switch in a data center includes receiving, by a photonic switch controller from an operations and management center, a condition in a first traffic flow between a first component and a second component, where the first traffic flow includes a second traffic flow along a first optical link between the first component and the photonic switch and a third traffic flow along a second optical link between the photonic switch and the second component to produce a detected traffic flow. The method also includes adjusting, by the photonic switch controller, connections in the photonic switch in accordance with the detected traffic flow including adding an added optical link or removing a removed optical link.

An embodiment method of controlling a photonic switch in a data center includes obtaining a peripheral connectivity level map and determining a switch connectivity map. The method also includes determining a photonic switch connectivity in accordance with the peripheral connectivity level map and the switch connectivity map and configuring the photonic switch in accordance with the photonic switch connectivity.

The foregoing has outlined rather broadly the features of an embodiment of the present invention in order that the detailed description of the invention that follows may be better understood. Additional features and advantages of embodiments of the invention will be described hereinafter, which form the subject of the claims of the invention. It should be appreciated by those skilled in the art that the conception and specific embodiments disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawing, in which:

FIG. 1 illustrates an embodiment data center;

FIG. 2 illustrates an embodiment data center with a photonic switch;

FIG. 3 illustrates embodiment junctoring patterns;

FIG. 4 illustrates an embodiment control structure for photonic switching in a data center;

FIG. 5 illustrates a graph of traffic level versus time of day;

FIG. 6 illustrates a graph of traffic level versus day of the week;

FIG. 7 illustrates a graph of traffic level versus time of day;

FIG. 8 illustrates a graph of traffic level versus time;

FIG. 9 illustrates an embodiment data center with a core switching failure;

FIG. 10 illustrates an embodiment data center with a photonic switch and a core switching failure;

FIG. 11 illustrates an additional embodiment data center with a photonic switch and a core switching failure;

FIG. 12 illustrates another embodiment data center with a photonic switch and a core switching failure;

FIG. 13 illustrates an additional embodiment data center with a core switching failure;

FIG. 14 illustrates an additional embodiment data center with a photonic switch and a core switching failure;

FIG. 15 illustrates another embodiment data center with a photonic switch and a core switching failure;

FIG. 16 illustrates an additional embodiment data center with a photonic switch and a core switching failure;

FIG. 17 illustrates another embodiment control structure for photonic switching in a data center;

FIG. 18 illustrates an embodiment data center with powered down core switching modules;

FIG. 19 illustrates an embodiment data center with a photonic switch with powered down core switching modules;

FIG. 20 illustrates an embodiment data center with a photonic switch and test equipment;

FIG. 21 illustrates another embodiment data center;

FIG. 22 illustrates another embodiment data center with a photonic switch and test equipment;

FIG. 23 illustrates an additional embodiment data center with a photonic switch;

FIG. 24 illustrates a photonic switching structure;

FIG. 25 illustrates a micro-electro-mechanical system (MEMS) photonic switch;

FIG. 26 illustrates an embodiment method of linking packets in a data center;

FIG. 27 illustrates an embodiment method of adjusting links in a data center;

FIG. 28 illustrates another embodiment method of adjusting links in a data center;

FIG. 29 illustrates an embodiment method of adjusting links in a data center in response to a component failure;

FIG. 30 illustrates an additional embodiment method of adjusting links in a data center;

FIG. 31 illustrates an embodiment method of testing components in a data center;

FIG. 32 illustrates an embodiment method of testing components in a data center; and

FIG. 33 illustrates another embodiment method of controlling a photonic switch in a data center.

Corresponding numerals and symbols in the different figures generally refer to corresponding parts unless otherwise indicated. The figures are drawn to clearly illustrate the relevant aspects of the embodiments and are not necessarily drawn to scale.

### DETAILED DESCRIPTION OF ILLUSTRATIVE EMBODIMENTS

It should be understood at the outset that although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

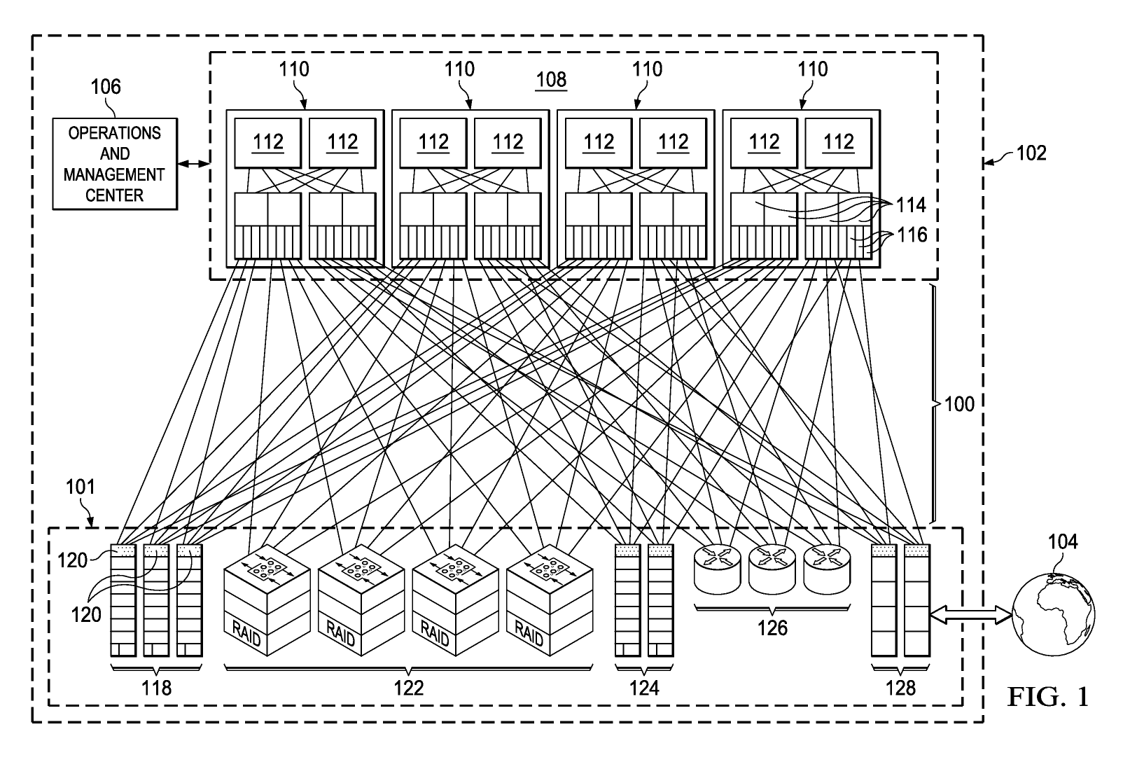

Data centers use massive arrays of peripherals composed of racks of servers. Each rack feeds a top of rack (TOR) switch or statistical multiplexer, which feeds multiplexed packet data streams via high capacity links to a core packet switch. In an example, the high capacity links are optical links. FIG. 1 illustrates data center 102. Packet switching core 108 of data center 102 contains packet switches 110, a parallel array of packet switching core 112. Packet switches 110 are very large packet switches. Packet switches 110 may also contain four quadrants 114 and core packet switching ports 116 or other similar partitioning.

Links 100, which may be short reach optical fibers, connect packet switching core 108 to peripherals 101. Links 100 are configured in a fixed orthogonal junctoring pattern of interconnections, providing a fixed map of connectivity at the physical levels. The connections are designed to distribute the switch capacity over peripherals 101 and to allow peripherals 101 to access multiple switching units, so component failures reduce the capacity, rather than strand peripherals or switches. The fixed junctoring structure is problematic to change, expand, or modify. A data center may contain 2000 bidirectional links at 40 Gb/s, which may have a capacity of 80 Tb/s or 10 TB/s. The links may have a greater capacity.

Peripherals 101, which may be assembled into racks containing top of rack (TOR) switches 120, may include central processing units (CPUs) 118, storage units 122, firewall load balancers 124, routers 126, and transport interfaces 128. TOR switches 120 assemble the packet streams from individual units within the racks, and provide a level of statistical multiplexing. Also, TOR switches 120 drive the resultant data streams to and from the packet switching core via high capacity short reach optical links. In an example, a TOR switch supports 48 units and has a 10 Gb/s interface. For CPUs 118, TOR switches 120 may each take 48×10 Gb/s from processors, providing 4×40 Gb/s to packet switching core 108. This is a 3:1 level of data compression of bandwidth. Storage units 122, routers 126, and transport interfaces 128 interface to the rest of the world 104 via internet connectivity or dedicated data networks.

Operations and management center (OMC) 106 oversees the complex data center operations, administration, and maintenance functions. OMC 106 has the capability to measure traffic capacity. For example, OMC 106 measures when and how often traffic links between peripherals 101 and packet switching core 108 become congested. Additionally, OMC 106 measures which links are functional for maintenance purposes.

FIG. 1 only illustrates a few racks of peripherals and relatively few links between peripherals 101 and the packet switching core 108. However, many more peripherals and links may be present. For example, a data center may have a throughput of 80 Tb/s, with 2000 40 Gb/s links to packet switching core 108 and 2000 40 Gb/s links from packet switching core 108 to peripherals 101. A data center may have 500 or more racks of peripheral equipment. An even larger data center of 1 Pb/s may have 25,000 bidirectional links to and from the central switching complex, with 6000 or more racks of peripherals.

Traffic from peripherals 101 is distributed in parallel over packet switches 110. Because the loads of peripherals 101 are distributed over packet switching core 108, a partial fabric failure does not strand a peripheral. The failure of one of n large packet switches reduces the overall switching capacity available to each peripheral unit to (n−1)/n. For example, when n=4, the switching capacity is reduced by twenty five percent.

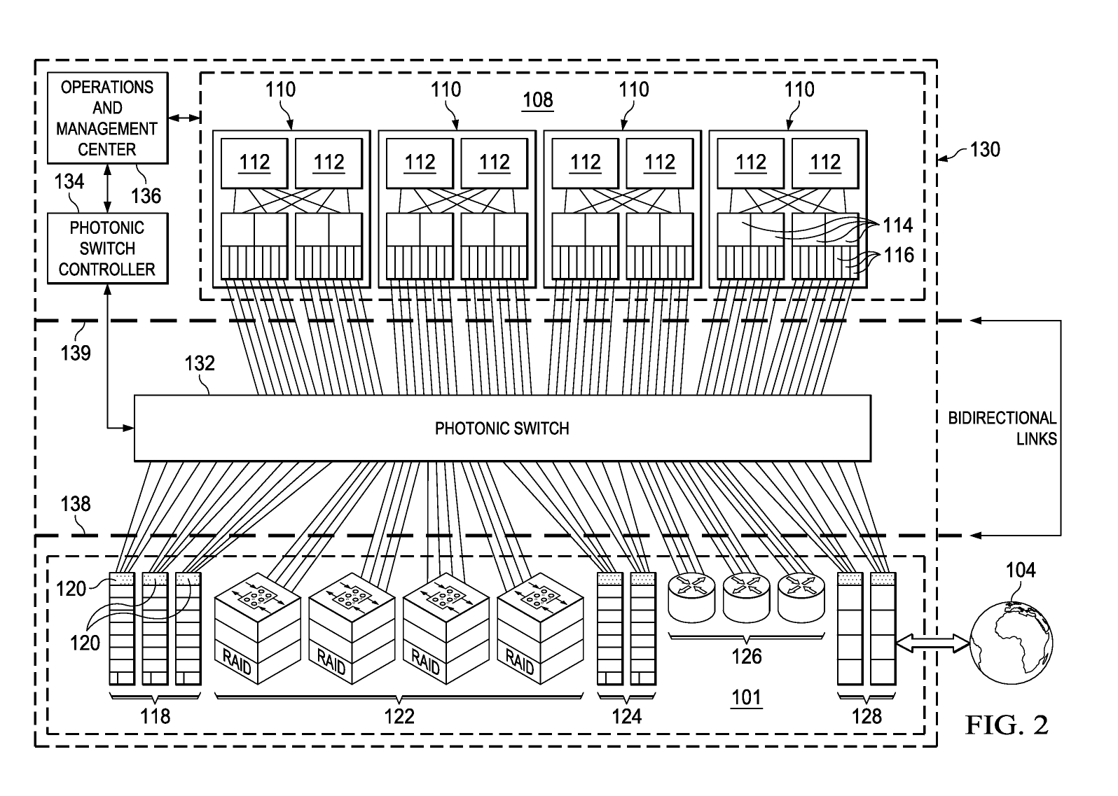

FIG. 2 illustrates data center 130 that contains a low loss photonic switch 132 between and packet switching core 108 and the core packet switching ports. Photonic switch 132 is configured to adjust the links between peripherals 101 and packet switching core 108. Photonic switch 132 may be a very large photonic switch, for example with 2000 or more ports. A very large photonic switch may be a multi-stage switch assembled from smaller fabrics of a few hundred ports each in one of several potential architectures. In an example, photonic switch 132 is a non-blocking photonic switch. In another example, photonic switch 132 is a rearrangeably non-blocking photonic switch. Some or all of core packet switch ports 116 may be terminated on photonic switch 132. In one example, photonic switch 132 has additional port capacity that is currently unused. Photonic switch 132 enables the junctoring pattern between peripherals 101 and packet switching core 108 to be set up and varied dynamically. Hence, the association of physical peripheral ports and physical switch ports is not fixed. Links 138 connect peripheral 101 and photonic switch 132, while links 139 connect photonic switch 132 to packet switching core 108.

Photonic switch controller 134 controls the photonic switch cross-connection map for photonic switch 132 under control from OMC 136. OMC 136 receives alarms and status reports from packet switching core 108 and peripherals 101 concerning the functioning of the equipment, traffic levels, and whether components or links are operating correctly or have failed. Also, OMC 136 collects real time traffic occupancy and link functionality data on the links between peripherals 101 and packet switching core 108.

In one example, OMC 136 passes the collected data to photonic switch controller 134. In another example, photonic switch controller 134 directly collects the traffic data. In both examples, photonic switch controller 134 processes the collected data and operates the photonic switch based on the results of its computations. The processing depends on the applications implemented, which may include dynamically responding in real time to traffic level changes, scheduled controls, such as time of day and day of week changes based on historical projections, dynamically responding to link failures or packet switch core partial failures, and reconfiguration to avoid powered down devices. For example, the period-by-period basis is an appropriate interval to the data, which may be significantly less than a second for link failure responses, tens of seconds to minutes to identify growing traffic hot-spots, hours or significant parts thereof for time of day projections, days or significant parts thereof for day of week projections, and other time periods.

The traffic capacity data is used by photonic switch controller 134 to determine the link capacities between peripherals 101 and packet switching core 108. In one example, the link capacities are dynamically calculated based on actual measured traffic demand. In another example, the link capacities are calculated based on historical data, such as the time of day or day of week. Alternatively, the link capacities are calculated based on detecting an unanticipated event, such as a link or component failures. In some applications, the link capacities are achieved purely based on historical data. For example, at 6:30 pm on weekdays, the demand for capacity on the video servers historically ramps up, so additional link capacity is added between those servers and the packet switching core. Then, the capacity is ramped down after midnight, when the historical data shows the traffic load declines. Other applications involve link capacity being added or removed based on demand or link saturation. For example, one TOR switch may have traffic above a traffic capacity threshold for a period of time on all links to that TOR switch, so the system will add a link from a pool of spare links to enable that TOR switch to carry additional traffic. The threshold for adding a link might depend on both the traffic level and the period of time. For example, the threshold may be above seventy five percent capacity for 10 minutes, above eighty five percent capacity for 2 minutes, or above ninety five percent capacity for 10 seconds. The threshold is not required to respond to very short overloads caused by the statistical nature of the traffic flow, since this is handled by flow control buffering. Also, MEMS switches, if used, being slow switches, cannot respond extremely rapidly. With a switch having a response time in the 30-100 ms region, switching photonic connections is not an effective solution for events of durations of less than multiple seconds to several minutes. Hence, long periods of slow traffic changes are handled by this process, and enough capacity is retained for short duration traffic peaks to be handled in a conventional manner with buffers and/or back-pressure to the sources. If the photonic switch used can be set up faster, for example in 3-10 ms, traffic bursts of a second or so may be responded to. In another example, the links are added or changed in response to a sudden change in traffic. For example, a link may become non-functional, leaving a TOR switch with only three of its four links, so the traffic on those links has jumped from sixty eight percent to ninety five percent, which is too high. Then, that TOR switch receives another link to replace the non-functional link.

After the required link capacity levels are determined by photonic switch controller 134, they are compared against the actual provisioned levels, and the differences in the capacity levels are determined. These differences are analyzed using a junctoring traffic level algorithm to capture the rules used to determine whether the differences are significant. Insignificant differences are marked for no action, while significant differences are marked for an action. The action may be to remove packet switch port capacity from the peripherals, add packet switch port capacity to the peripherals, or change links between the packet switching core and the peripherals.

When the capacity changes have been determined in terms of link levels or link capacity, photonic switch controller 134 applies these changes to the actual links based on a specific link identity. For example, if a TOR switch was provisioned with four links, and the traffic levels justify a reduction to two links, two of the links would be disconnected from the TOR switch. The corresponding packet switching core links are also removed and returned to the spare link inventory. The physical links between the TOR switch and photonic switch 132 are associated with specific switch ports and TOR ports, and cannot be reconfigured to other switch ports or TOR ports. In another example, a TOR switch has been operating on three links, which are highly occupied, and photonic switch controller 134 determines that the TOR switch should have a fourth link. A spare link in the inventory is identified, and that link is allocated to that TOR switch to increase the available capacity of the TOR switch and reduce its congestion by reducing delays, packet buffering, packet buffer overflows, and the loss of traffic.

The capacity of packet switching core 108 is thus dynamically allocated where it is needed and recovered where excess capacity is detected. The finite capacity of packet switching core 108 may be more effectively utilized over more peripherals while retaining the capacity to support the peak traffic demands. The improvement is more substantial when peak traffic demands of different peripherals occur at different times.

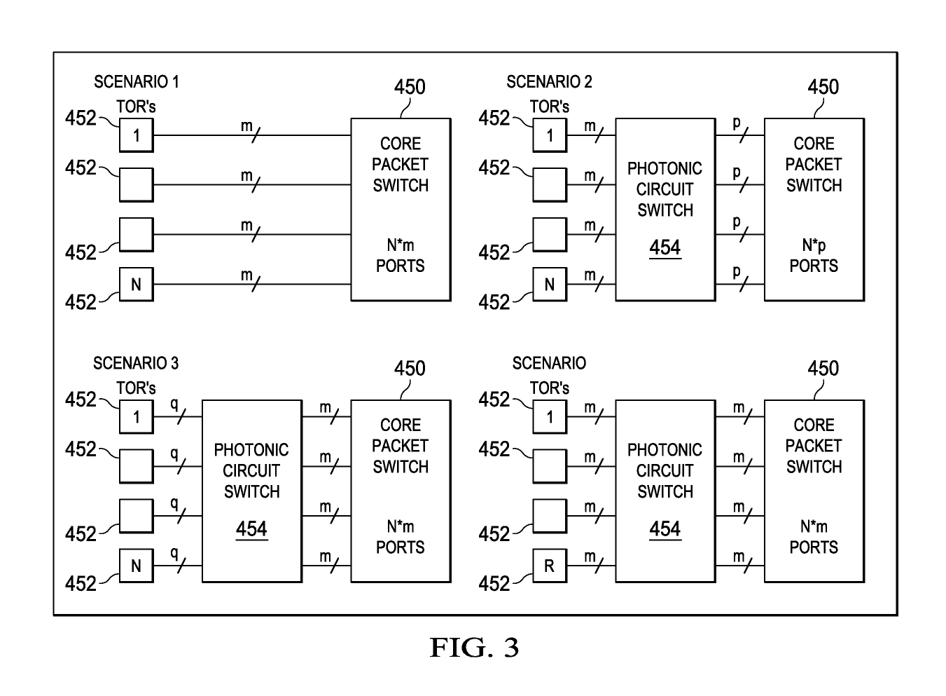

The use of photonic switch 132 can increase the number of peripherals that may be supported by a packet switching core, and the peak traffic per peripheral that can be supported. FIG. 3 illustrates four data center scenarios. In scenario 1, there is no photonic switch, and packet switching core 450 is coupled to N TOR switches 452 each with m physical links in a static junctoring pattern. A peak traffic load capability of m physical links per TOR switch is available whether the peak traffic on all TOR switches occurs simultaneously or the timing of per-TOR switch traffic peaks is distributed in time. The N TOR switches each with m physical links and a peak traffic load of m physical links requires a packet switching core with N*m ports.

In scenarios 2, 3, and 4, photonic switch 454 is coupled between packet switching core 450 and TOR switches 452. Photonic switch 454 is used to rearrange the junctoring connections between the packet switch ports and the TOR switch ports under the control of photonic switch controller 134. When the TOR switch traffic peaks are not simultaneous across all TOR switches, the capacity improved.

In scenario 2, N TOR switches with m physical links per TOR switch are illustrated. Because the TOR switches do not need to access a peak traffic capability simultaneously, the links between the TOR switches and the switch ports are adaptively remapped by photonic switch controller 134 and photonic switch 454 to enable TOR switches that are not fully loaded to relinquish some of their port capacity. This enables the number of switch ports to be reduced from N*m to N*p, where p is the average number of ports per TOR switch to provide adequate traffic flow. The adequate traffic flow is not the mean traffic level required, but the mean traffic flow plus two to three standard deviations in the short term traffic variation around that mean, where short term is the period of time when the system would respond to changes in the presented traffic load. The cutoff is the probability of congestion on the port and the consequent use of buffering, packet loss, and transmission control protocol (TCP) re-transmission. If the mean traffic levels are used, the probability of congestion is high, but if the mean and two to three standard deviations is used, the probability of the traffic exceeding the threshold is low. The average number of active links per active TOR switch is about p, while the peak number of active links per TOR switch is m.

In scenario 3, because photonic switch controller 134 removes unnecessary TOR packet switch links and returns them to the spare pool, the number of links allocated to heavily loaded TOR switches may be increased. The fixed links from TOR switches 452 to the TOR switch side of photonic switch 454 would may be increased, bringing the links per TOR switch up from m to q, where q>m. In this scenario, the same number of TOR switches can be supported by the same packet switch, but the peak traffic per TOR switch is increased from m to q links if the peaks are not simultaneous. The peak traffic per TOR switch may be m links if all the TOR switches hit a peak load simultaneously. The average number of links per TOR switch is about m, while the peak number of active links per TOR switch is q.

In scenario 4, the packet switch capacity, the peak TOR switch required traffic capacity, and links per TOR switch remain the same. This is due to the ability to dynamically reconfigure the links. Thus, the number of TOR switches can be increased from N to R, where R>N. The average number of active links per TOR switch is about m*N/R, and the peak number of active links per TOR switch is m.

The levels of p, q, and R depend on the actual traffic statistics and the precision and responsiveness of photonic switch controller 134. In one example, the deployment of a photonic switch controller and a photonic switch enables a smaller core packet switch to support the original number of TOR switches with the same traffic peaks. Alternatively, the same sized packet switch may support the same number of TOR switches, but provide them with a higher peak bandwidth if the additional TOR links are provided. In another example, the same sized packet switch supports more TOR switches with the same peak traffic demands.

In a general purpose data center, the peak traffic loads of the TOR switches are unlikely to coincide, because some TOR switches are associated with racks of residential servers, such as video on demand servers, other TOR switches are associated with racks of gaming servers, and additional TOR switches are associated with racks of business servers. Residential servers tend to peak in weekday evenings and weekends, and business servers tend to peak mid-morning and mid-afternoon on weekdays. Then, the time-variant peaks of each TOR-core switch load can be met by moving some time variant link capacity from other TOR-core switch links on the TOR switches not at peak load and applying those links to TOR switches experiencing peak loads.

In data center 130, the maximum capacity connectable to a peripheral is based on the number of links between the peripheral and photonic switch 132. These fixed links are provisioned to meet the peripheral's peak traffic demand. On the packet switching core side of photonic switch 132, the links may be shared across all the peripherals allocating any amount of capacity to any peripheral up to the maximum supported by the peripheral-photonic switch link capacity, provided that the sum of all the peripheral link capacities provisioned does not exceed the capacity of the packet switch core links to the photonic switch. The links between photonic switch 132 and packet switching core 108 only need to provide the required capacity actually needed for the actual levels of traffic being experienced by each peripheral. For example, if packet switching core 108 has 100 ports serving a suite of peripherals each having four ports, and a peak traffic demand fully utilizing those four ports, but an average demand of traffic level (mean+2-3 standard deviations) equivalent to 2.5 ports, without use of photonic switch 132 and photonic switch controller 134, packet switching core 108 could support 100/4=25 TOR switches. On average, packet switching core 108 runs at 2.5/4=62.5% of the maximum capacity. After the addition of photonic switch 132 and photonic switch controller 134, packet switching core 108 can support up to 100/2.5=40 peripherals in an ideal situation where the total traffic stays below the average. In practice, a significant gain may be realized, for example increasing the peripheral count from 25 to 30 or 35.

Photonic switch 132 may be extremely large. In one example, photonic switch 132 contains one photonic switching fabric. In another example, photonic switch 132 contains two photonic switching fabrics. When two photonic switching fabrics are used, one fabric cross-connects the peripheral output traffic to the packet switching core input ports, while the second photonic switching fabric switches the packet switching core output traffic to the peripheral inputs. With two photonic switching fabrics, any links may be set up between peripherals 101 and packet switching core 108, but peripheral-to-peripheral links, switch loop-backs, or peripheral loop-backs are not available. With one photonic switching fabric, the photonic switching fabric has twice the number of inputs and outputs, and any peripheral or packet switching core output may be connected to any peripheral or packet switching core input. Thus, the one photonic switching fabric scenario facilitates peripheral-to-peripheral links, switch loop-backs, peripheral-link backs, and C-Through capability, a method of providing a direct data circuit between peripherals and bypassing the packet switching core.

By appropriately setting up the cross-connection paths using photonic switch controller 134, photonic switch 132 may set up the same junctoring pattern as in data center 102. However, photonic switch controller 134 may be used to adjust connections in photonic switch 132 to achieve other capabilities. Junctoring may be varied by operating the photonic switch under control of a controller, stimulated by various inputs, predictions, measurements and calculations. For example, the junctoring pattern may be adjusted based on the time of day to meet anticipated changes in traffic loads based on historical measurements. Alternatively, the junctoring pattern may be adjusted dynamically in response to changing aggregated traffic loads measured in close to real time on peripherals or the packet switching core, facilitating peripherals to be supported by a smaller packet switching core by moving spare capacity between peripherals that are lightly loaded and those that are heavily loaded. The impact of a partial equipment failure on the data center's capacity to provide service may be reduced by routing traffic away from the failed equipment based on the impact of that failure on the ability of the data center to support the load demanded by each TOR. Powering down equipment during periods of low traffic may be improved by routing traffic away from the powered down equipment. Peripherals and/or packet switching modules may be powered down during periods of low traffic. Operations, maintenance, equipment provisioning, and/or initiation may be automated. The data center may be reconfigured and/or expanded rapidly with minimal disruption. Also, the integration of dissimilar or multi-generational equipment may be enhanced.

In an embodiment, a history of per-peripheral loads over a period of time is built up containing a time-variant record by hour, day, or week of the actual traffic load, as well as the standard deviation of that traffic measured over successive instantiations of the same hour of the day, day of the week, etc. This history is then used for capacity allocation forecasts, thereby facilitating TORs which have a history of light traffic loads at specific times to yield some of their capacity to TORs which historically have a record of a heavy load at that time. The measurement of the standard deviation of the loads and the setting of traffic levels to include the effects of that standard deviation has the effect of retaining enough margin that further reallocation of bandwidth is likely not to be a commonplace event. In the event of a significant discrepancy between the forecast and the actual load, this optionally may be adjusted for in real time, for instance by using the alternative real time control approach.

As an alternative to setting up the loads of the peripherals based on history, or to handle exceptional cases after the historical data has been applied, the server loads of each peripheral or TOR switch are measured in quasi-real time. The server loads on a rack by rack or TOR switch by TOR switch basis may be aggregated into a set of user services. As the server rack approaches exhaustion of its link capacity, additional links are allocated to that peripheral. Conversely, if a traffic level drops down to a level not justifying the number of allocated links, some link capacity can be returned to the link pool. If the peripheral later needs more links, the links can be rapidly returned.

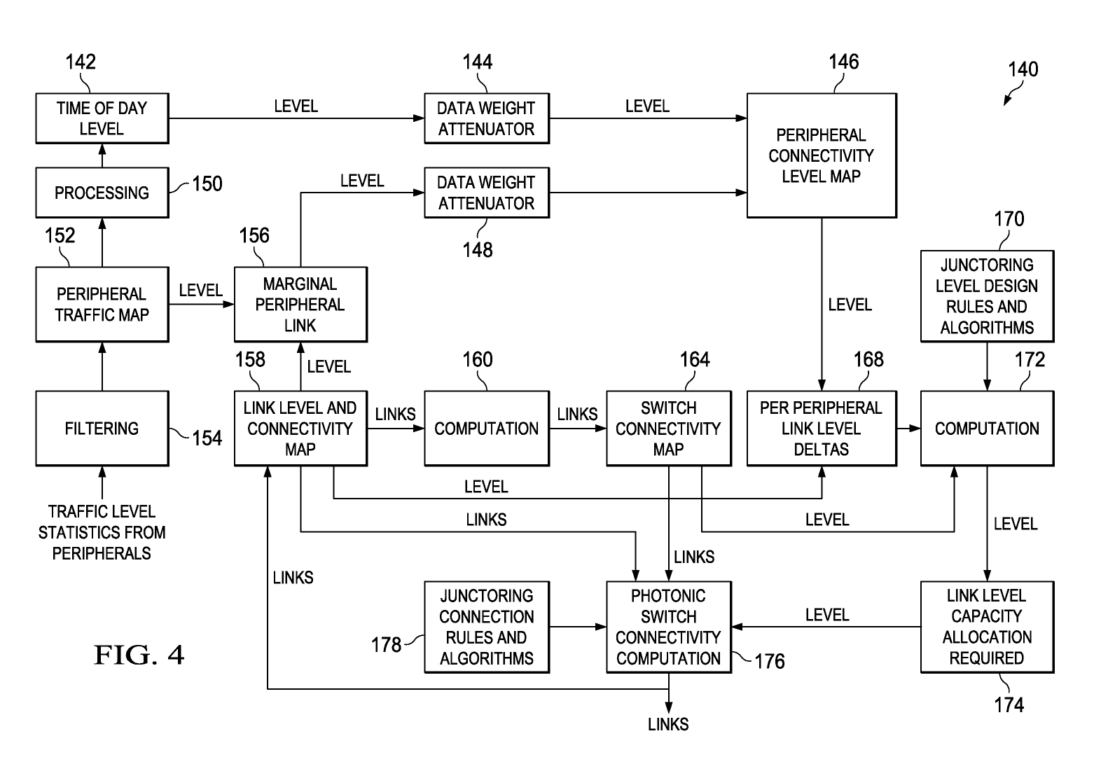

FIG. 4 illustrates control structure 140, which may allocate links between peripherals and a packet switching core. Control structure 140 may be used, for example, in photonic switch controller 134. Control structure 140 adjusts the junctoring pattern of the data center by controlling a photonic switch coupled between peripherals and a packet switching core based on scheduled junctoring connectivity, for instance based upon historical data and/or dynamic connectivity based on the real time traffic needs of peripheral.

The portions of control structure 140 labeled “level” determine the link allocation to peripheral, and are unconcerned by the identity of the links, only by the number of links. The portions of control structure 140 labeled “links” adjust the junctoring pattern, and are concerned with the identity of the links.

Traffic level statistics enter control structure 140, for example directly from peripheral 101 or from OMC 136. Filtering block 154 initially processes the traffic level statistics to significant data. For example, data on traffic levels may be received in millisecond intervals, while control structure 140 controls a photonic switch with a setup time of about 30 to about 100 milliseconds if using conventional MEMS switches, which cannot practically respond to a two millisecond duration overload, and which would be handled by buffering and flow control within the TCP/IP layer. The traffic level data is filtered down, for example aggregated and averaged, to produce a rolling view of per-peripheral actual traffic levels, for example at a sub one second rate. Additional filtering may be performed. Some additional filtering may be non-linear. For example, the initial filtering may respond more rapidly to some events, such as a loss of connectivity messages when links fail, than to other events, such as slowly changing traffic levels. The initial filtering may respond more rapidly to large traffic changes than to small traffic changes, since large changes would create a more severe buffer overload/flow control event.

The filtered data is passed on to peripheral traffic map 152. The data may be received in a variety of forms. For example, the data may be received as a cyclically updated table, as in by Table 1. Peripheral traffic map 152 maintains the current view of the actual traffic loads of the peripherals at an appropriate granularity. Also, peripheral traffic map 152 maintains the current needs of actual applications. Table 2 below illustrates data maintained by peripheral traffic map 152.

TABLE 1

| | | Link Occupancy | | | |
|---|---|---|---|---|---|
| Timestamp | TOR# | Link #1 | Link#2 | Link#3 | Link#4 |
| 00:00:00 | 0001 | 0.75 | 0.82 | 0.39 | 0 (no link) |
| | 0002 | 0.45 | 0.51 | 0.56 | 0.71 |
| | 0003 | 0.32 | 0.32 | 0.15 | 0.20 |
| | . . . | | | | |
| | N-1 | 0.78 | 0.92 | 0.88 | 0 (no link) |
| | N | 0.32 | 0.35 | 0.42 | 0.31 |
| 00:00:01 | 0001 | 0.68 | 0.71 | 0.44 | 0 (no link) |
| | 0002 | 0.39 | 0.56 | 0.62 | 0.59 |
| | 0003 | 0.36 | 0.40 | 0.42 | 0.24 |
| | . . . | | | | |

TABLE 2

| | Traffic- | Traffic- | Traffic- | Traffic- | Traffic- |
|---|---|---|---|---|---|
| | Last | Last | Last | Last | Last |
| TOR | Second | 10 Secs | Minute | Hour | Day |
| 0001 | 1.96 | 1.52 | 1.33 | 1.29 | 1.07 |
| 0002 | 2.23 | 2.57 | 3.43 | 3.92 | 2.21 |
| 0003 | 0.99 | 1.63 | 1.45 | 1.43 | 2.65 |
| . . . | | | | | |
| N-1 | 2.58 | 2.64 | 2.99 | 2.82 | 1.32 |
| N | 2.40 | 2.10 | 1.82 | 1.43 | 1.12 |
| Update rate | 1 per | 1 per | 1 per | 1 per | 1 per |
| (example) | sec | sec | 10 sec | 5 min | hour |

The actual measured per-peripheral traffic levels are passed from peripheral traffic map 152 to processing block 150. Processing block 150 combines the per-peripheral traffic levels with processed and stored historical data. The stored historical data may include data from one hour before, 24 hours before, seven day before, one year before, and other relevant time periods.

The projected map from processing block 150 is stored in time of day level block 142, which contains a regularly updated historical view of the time of day variant traffic levels that are expected, and on statistical spreads, for example in a numerical tabular form. Depending on the granularity and complexity of the computation time offsets used in processing block 150, time of day level block 142 may also contain other traffic level forecasts by peripheral. For example, time of our time of day by day of week, or statutory holidays based on the location of the data center may be recorded.

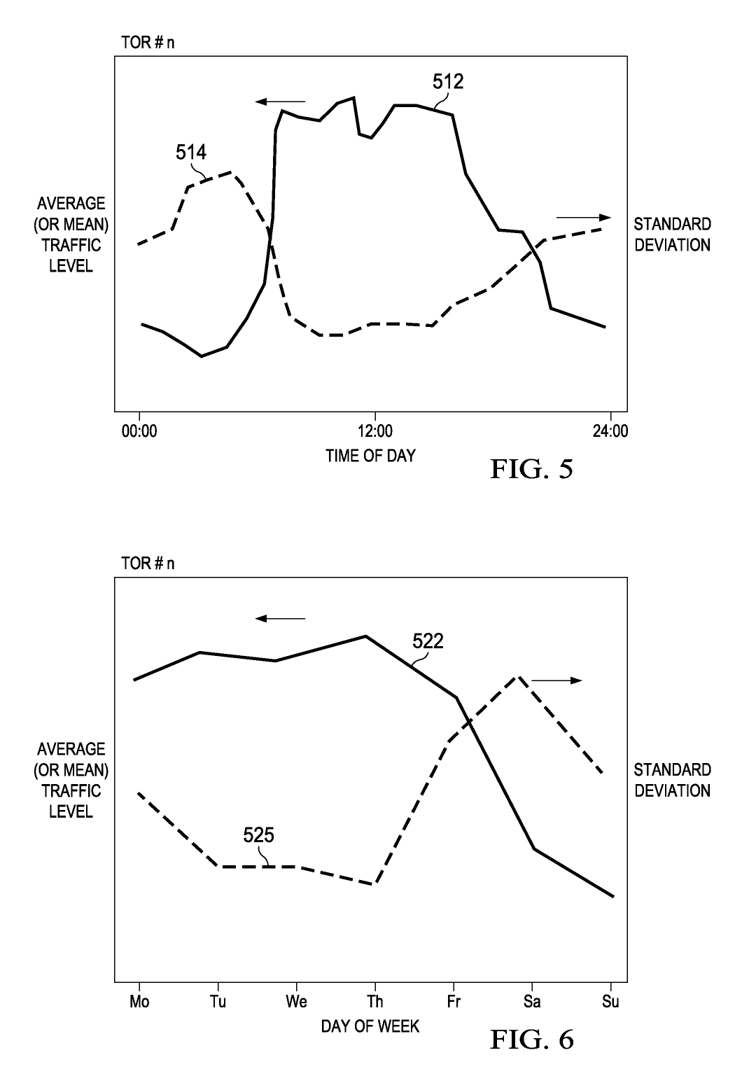

FIG. 5 illustrates an example of a graph of the mean traffic level and standard deviation by time of day, for instance for a bank of TORs dealing with business services. Curve 512 shows the mean traffic level by time of day, while curve 514 shows the standard deviation by time of day for the same bank of TORs. In this example, there is more traffic in the middle of the day than at night, with more variation at night.

FIG. 6 illustrates an example of a graph of the mean traffic level and standard deviation by day of week. Curve 522 shows the mean traffic level by the day of week, while curve 525 shows the standard deviation by day of week for the same example bank of TORs. There is more traffic during the week that on the weekend, with more variation during the weekend.

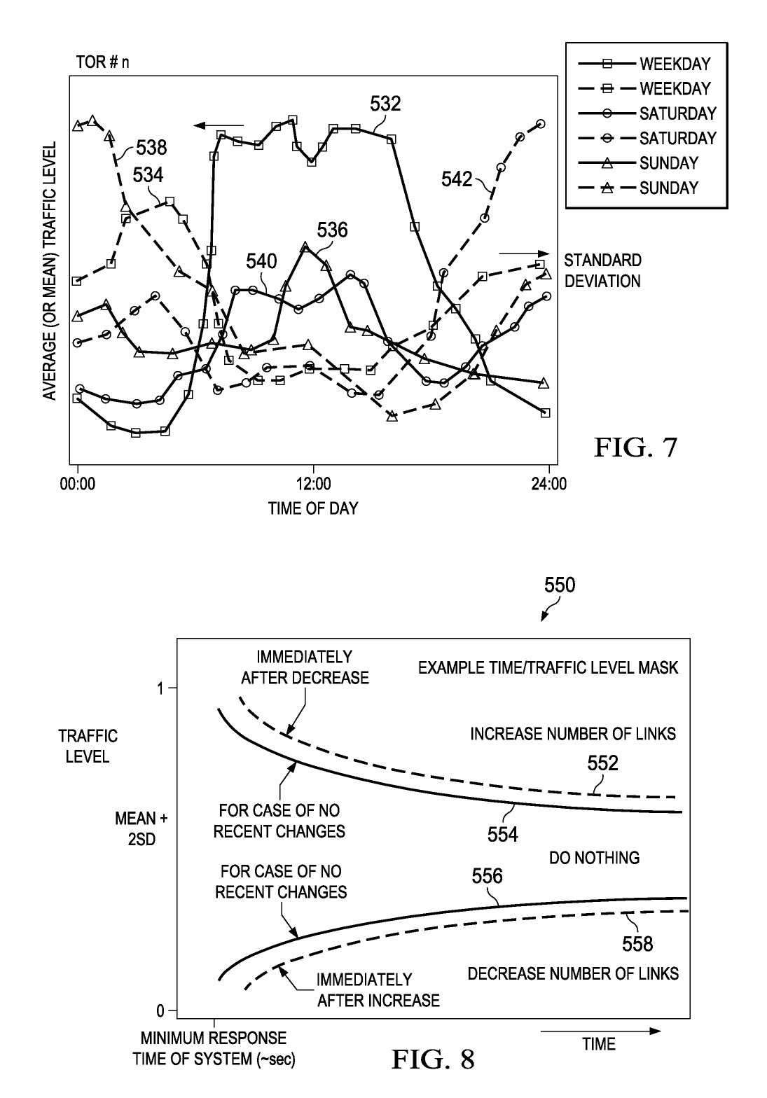

FIG. 7 illustrates another example of a graph for mean traffic level and standard deviation for time of day for weekdays, Saturdays, and Sundays. Curve 532 shows the mean traffic level versus time of day for weekdays, curve 534 shows the standard deviation for traffic by time of day for weekdays, curve 540 shows the mean traffic level by time of day on Saturdays, curve 542 shows the standard deviation for traffic by time of day for Saturdays, curve 536 shows the mean traffic level by time of day for Sundays, and curve 538 shows the standard deviation for traffic by time of day for Sundays. The traffic is greatest on weekdays during the day, and lowest weekdays in the middle of the night. Traffic also peaks on Saturday and Sunday in the middle of the night, and Saturday night.

Other TORs, being used with banks of game servers, banks of entertainment/video on demand servers, or general internet access and searching would show completely different time of day, time of week traffic patterns to those of the business servers and bank of TORs of FIGS. 5-7. For instance, these banks of TORs may show high levels of traffic during evenings weekends, and lower levels during the business day. Hence, if this pattern can be predicted or detected, core switching capacity can be automatically moved from one server group to another based upon the traffic needs of that group.

Peripheral traffic map block 152 also provides data on the actual measured traffic to marginal peripheral link capacity block 156. Marginal peripheral link block also accesses a real-time view of the actual provisioned link capacity, or the number of active links per peripheral multiplied by the traffic capacity of each link, from the current actual link connection map in link level and connectivity map block 158.

Link level and connectivity map block 158 contains an active links per peripheral map obtained from photonic switch connectivity computation block 176. Link level and connectivity map block 158 computes the actual available traffic capacity per peripheral by counting the provisioned links per peripheral in that map and multiplying the result by the per-link data bandwidth capacity.

Hence, marginal peripheral link capacity block 156 receives two sets of data, one set of data identifying the actual traffic bandwidth flowing between the individual peripherals and the packet switching core, and the other set of data provides the provisioned link capacity per peripheral. From this data, marginal peripheral link capacity block 156 determines which peripherals have marginal link capacity and which peripherals have excess capacity. The average and standard deviation of the traffic are considered. This may be calculated in a number of ways. In one example, the actual traffic capacity being utilized is divided at the two or three sigma point, the average plus two to three standard deviations, by the bandwidth capacity of the provisioned links. This method leads to a higher number for low margin peripheral, where link reinforcement is appropriate. Also, this method leads to a low number for high margin peripheral where link reduction is appropriate. For example, this might yield a number close to 1, for example 0.8, for a low margin peripheral, and a number close to zero, for example 0.2, for a high margin peripheral. Most peripherals, having adequate but not excessive link capacities, return numbers in the 0.4 to 0.6 range. The link reinforcement algorithm applied at the decision making point may be if a peripheral margin number greater than 0.75 is calculated, a link should be added, and if a peripheral margin number of less than 0.25 is calculated, a link is removed, and for values between 0.25 and 0.75, no action is performed.

Marginal peripheral link capacity block 156 produces a time variant stream of peripheral link capacity margins. Low margin peripherals are flagged and updated in a view of the per peripheral link capacity devices.

In another example, additional processing is performed, which may consider the time of day aspects at a provisionable level or additional time variant filtering before making connectivity changes to avoid excessive toggling of port capacities. This entails time-variant masking and hysteresis be applied to the results. For example, an almost complete loss of an operating margin should be responded to fairly promptly, but a slower response is appropriate for a borderline low margin. FIG. 8 illustrates time-variant mask 550, which may be used to filter responses to traffic changes. Curve 552 illustrates a threshold above which the number of links immediately increases. Between curve 552 and curve 554 is a hysteresis region to minimize toggling. Within this hysteresis region, the number of links is increased only when there have been no recent changes. Between curve 554 and curve 556, no action is performed. Between curve 556 and curve 558 is another hysteresis region, where the number of links is decreased if there have been no recent changes. Below curve 558, the number of links is immediately decreased.

Data weight attenuator block 144, data weight attenuator block 148, per peripheral connectivity level map 146, and per-peripheral link level deltas block 168 determine when links should be changed. These blocks operate together to produce an idealized target per-peripheral connection capacity map. The scheduled considers and measured changes in traffic levels based on predicted near-term future needs and measured changes in current needs that provides the basis for the motivations to the actual current connectivity capacity level map, and hence the link allocation.

Marginal peripheral link capacity block 156 provides peripheral connectivity level map 146 with the current view of the per-peripheral traffic levels for the peripherals that have marginal and excessive link capacity flagged for priority. Peripheral connectivity level map 146 also receives the traffic levels projected to be needed from the historical data from traffic level marginal peripheral link capacity block 156. These data streams are fed through data weight attenuator block 148 and data weight attenuator block 144, respectively. Data weight attenuator block 144 and data weight attenuator block 148 are pictured as separate blocks, but they may be implemented as a single module, or as a part of peripheral connectivity level map 146.

Data weight attenuator block 144 and data weight attenuator block 148 select the balance between scheduled junctoring and real time dynamic junctoring. For example, a value of one for data weight attenuator block 144 and a value of zero for data weight attenuator 148 select purely real time traffic control, a zero for data weight attenuator block 144 and a one for data weight attenuator 148 select purely scheduled traffic control, and intermediate values select a combination of scheduled and real time traffic control.

In another example, data weight attenuator block 144 and data weight attenuator block 148 include logical functions, such as a function to use the larger value of the measured and predicted traffic levels on the input ports of peripheral connectivity level map 146. This results in low levels of probability of link capacity saturation and delay, but is less bandwidth-efficient. In one example, the values used by data weight attenuator block 144 and data weight attenuator block 148 are the same for all peripherals. In another example, the values used by data weight attenuator block 144 and data weight attenuator 148 are customized for each peripheral or group of peripherals. For example, the larger value of the measured and predicted traffic levels may be used on peripherals associated with action gaming, where delays are highly problematic. Other peripherals may use a more conservative approach, enabling more efficient operation with a higher risk of occasionally having delays.

Peripheral connectivity level map 146 creates an ideal mapping of the overall level of available capacity in the data center for the levels of capacity that should be provided to each peripheral.

The map of the ideal levels (the number of links for each peripheral) is passed to per peripheral link level deltas block 168. Per-peripheral link level deltas block 168 also receives data on the current per-peripheral link levels from link level and connectivity map 158. Then, per peripheral link level deltas 168 compares the per-peripheral data ideal levels and the actual levels, and produces a rank ordered list of discrepancies, along with the actual values of the margins for those peripherals.

This list is passed to computation block 172, which applies rules derived from a list from junctoring design rules and algorithms 170. These rules introduce the time-variant nature of the decision process, and the rules cover additional requirements, such as the required link performance for each peripheral. The computation and rules may be dependent on the available spare capacity from switch connectivity map 164. In particular, the inventory of spare switch port connections within the map is determined by counting the number of spare switch ports.

The output from computation block 172 is passed to link level capacity allocation requirement block 174 in the form of a table of revised connection levels for the peripherals that have extra capacity and those that have insufficient capacities. In an example, the peripheral that have an appropriate capacity are not included in the table. In another example, the connection levels of all peripherals are output.

The table is passed to photonic switch connectivity computation block 176. Photonic switch connectivity computation block 176 computes changes to the link map based on the changes from the link level information and on an algorithm from junctoring connection rules and algorithms block 178. These rules may be based on links from switch connectivity map 164, the computed spare capacity, and identified spare switch links from switch connectivity map 164. Initially, photonic switch connectivity computation block 176 computes the connectivity map changes by computing the links by link identification number (ID) for links that may be removed from peripherals. These links are returned to the spare capacity pool. Next, photonic switch connectivity computation block 176 computes the reallocation of the overall pool of spare links by link ID to the peripherals that are most in need of excess capacity from the link level capacity list. These added links are then implemented by the photonic switch.

As photonic switch connectivity computation block 176 makes changes to the links, it updates link level and connectivity map 158. The changes are also output to the core packet switch routing map control, so the core packet switch can route packets to the correct port IDs to connect the new peripheral links.

Computation block 160 computes the switch connectivity map from link level and connectivity map 158. Computation block 160 then outputs the computed map to switch connectivity map 164.

A data center with a photonic switch controller may be used to handle the failure of a packet switching segment when a portion of a packet switching core fails, without the entire packet switching core failing. This might occur, for example, with a localized fire or power outage or a partial or complete failure of one of the packet switches of the packet switching core. The impact on any particular peripheral's functionality depends on whether that peripheral was wholly connected, partially, connected, or not connected to the affected portion of the packet switching component. Peripherals that are heavily connected to the failed switching component are most affected. With a fixed junctoring pattern, to the extent possible, the effects of a partial switching complex failure are spread out, leading to reduced service levels and longer service delays, rather than a complete loss of service to some users.

Inserting a photonic switch between the peripherals and the packet switching core enables the peripheral links to be rearranged. In the case of a failure, the peripheral links may be rearranged to equalize the degradation across all peripherals or to maintain various levels of core connectivity to peripherals depending on their priority or traffic load. By spreading out the effect of the failure, except at peak times, the effect on individual users may be unnoticeable, or at least minimized.

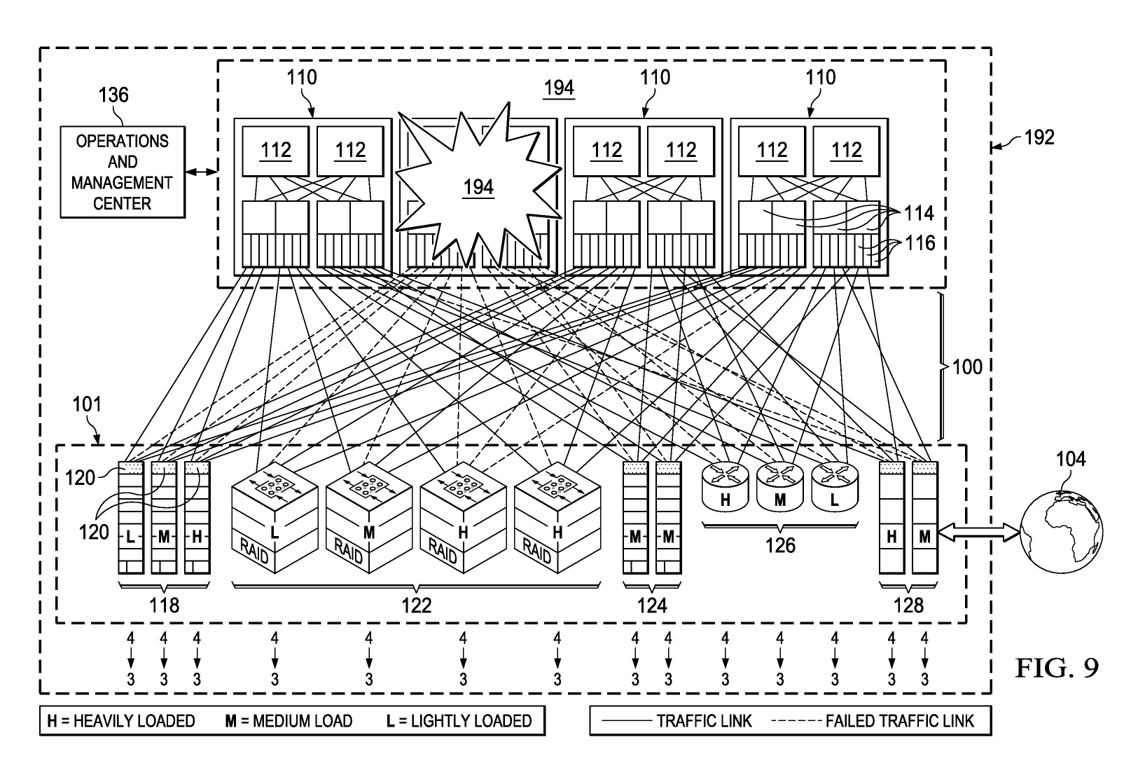

FIG. 9 illustrates data center 192 without a photonic switch and with failed packet switch 194. When packet switch 194 fails, 25% of connectivity is lost. That 25% is spread evenly across peripherals 101, irrespective of whether they are lightly loaded (L), heavily loaded (H), or moderately loaded (M). This is because the links from failed packet switch 194 are fixed. However, because peripherals 101 have different traffic loads, the loss of 25% of their capacity has a different impact on different peripherals, while the lightly loaded peripherals are likely to still have sufficient operating margin. The highly loaded peripherals are likely to be severely impacted with link congestion and delay. The moderately loaded peripherals are likely to operate adequately but at a lower than ideal link capacity margin.

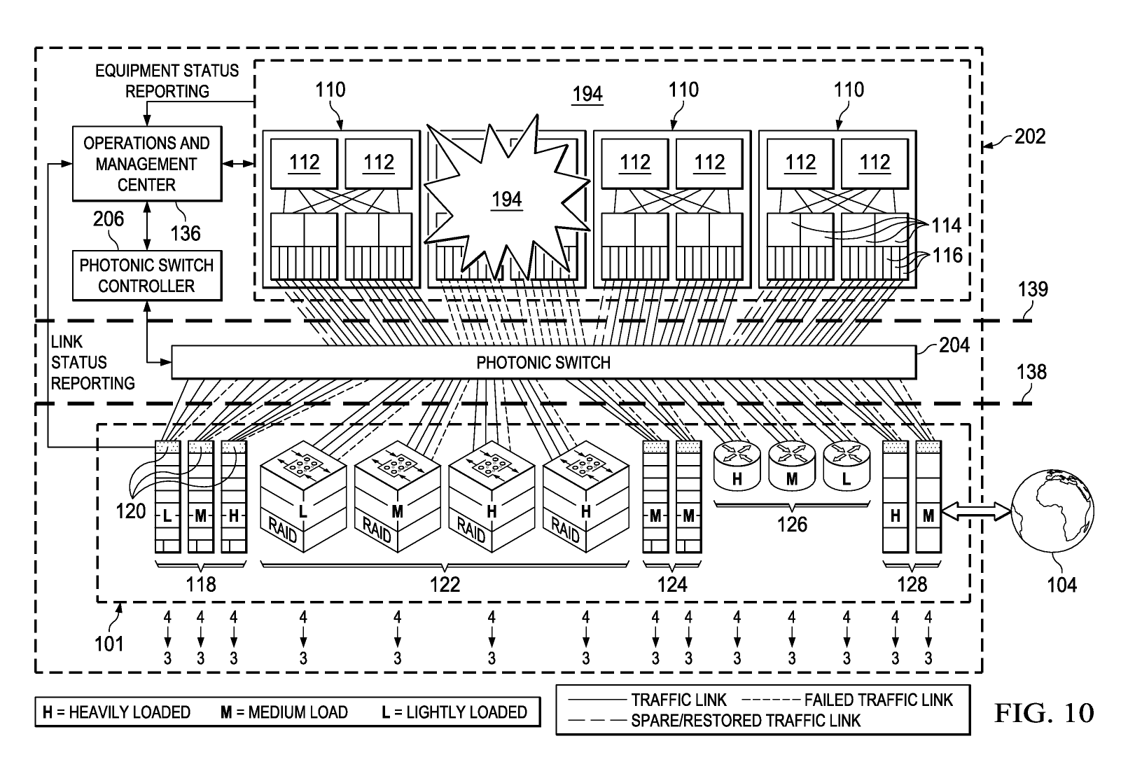

FIGS. 10, 11 and 12 illustrate the effect of the same failure and the ability to take corrective action when the photonic switch and its control system are present.

FIG. 10 illustrated data center 202 with photonic switch 204, failed packet switch 194, and photonic switch controller 206. Immediately after the failure of packet switch 194, peripherals 101 lose 25% of their capacity. However, this loss and the failure of packet switch 194 are reported to OMC 136 by peripherals 101 and packet switch 194. OMC 136 may already have a record of the traffic loading of peripherals 101. Alternatively, OMC 136 interrogates peripherals 101 to obtain the load information of peripherals 101. Based on this knowledge, spare switch capacity available in other packet switches may be re-deployed in accordance with need.

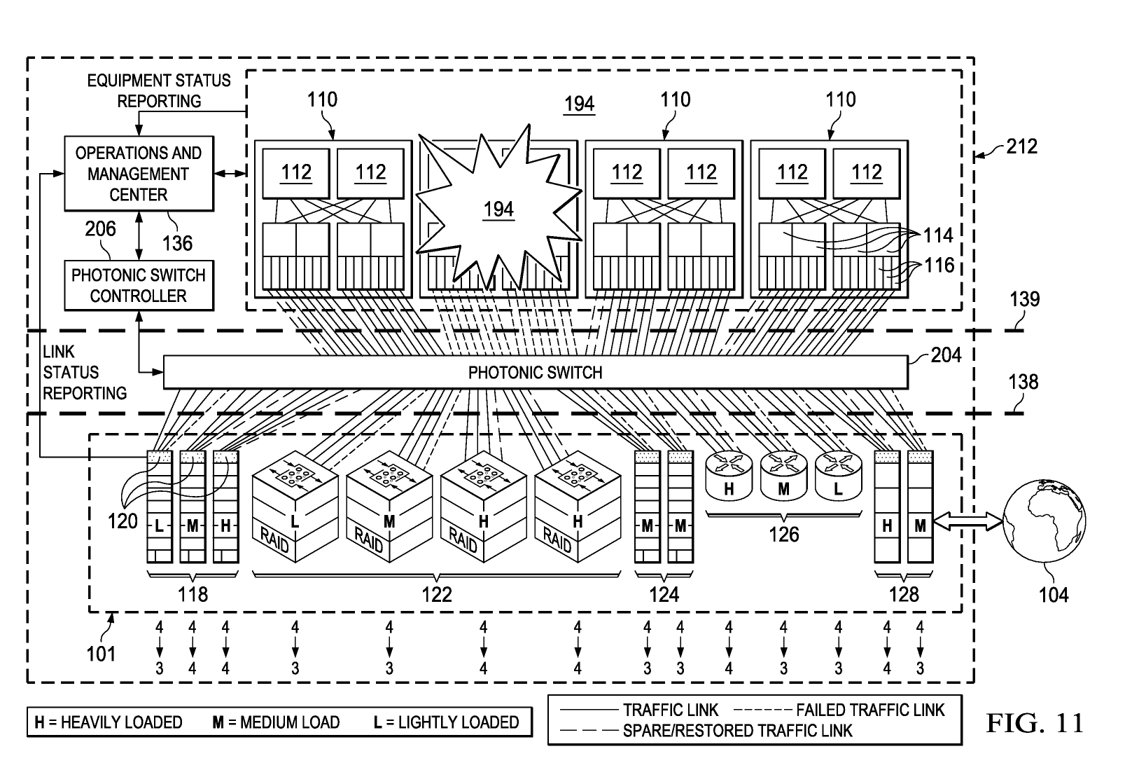

In FIG. 11, links 138 and links 139 are readjusted in data center 212 based on the failure of failed packet switch 194. In data center 212, the spare core packet switching capacity is inadequate to fully restore the capacity to all peripherals. The spare capacity is allocated to the highest traffic peripherals, resulting in the loss of capacity reducing capacity of the overall data center 212 by 15%, since, in this example, inadequate spare capacity has been retained to cover the entire failure, while high traffic peripherals are restored to full connectivity.

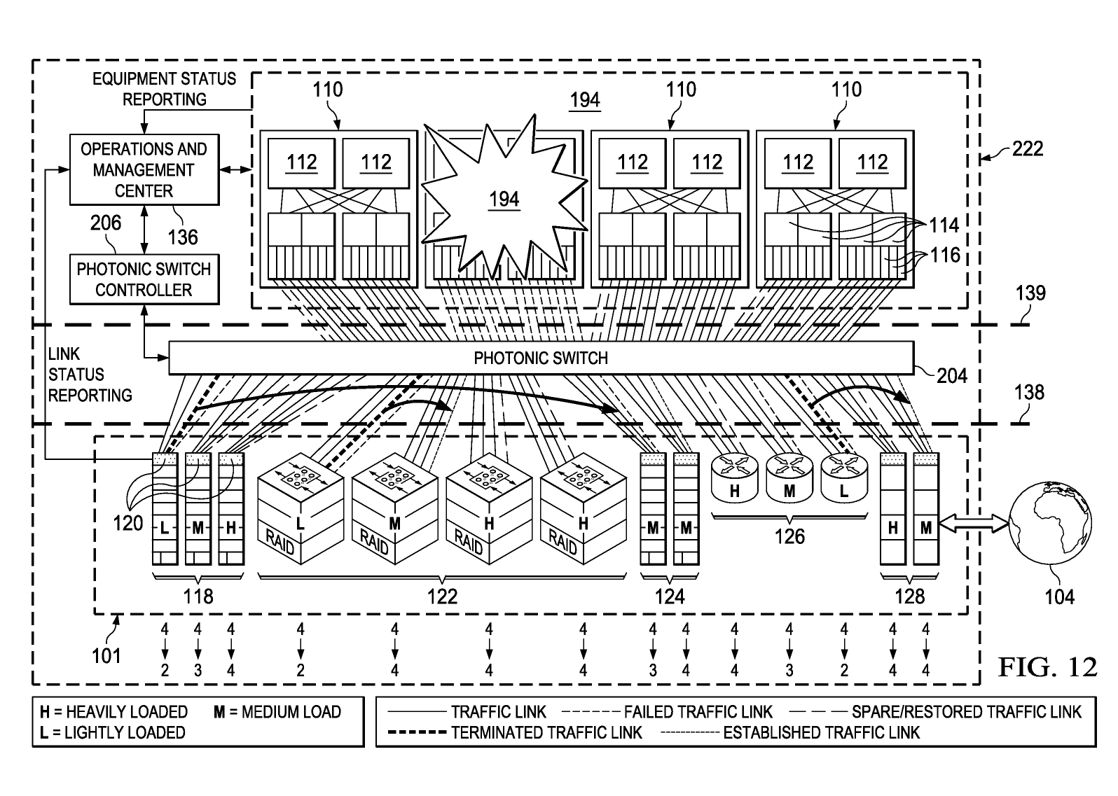

Some peripherals are operating at low traffic levels, and may operate normally with a reduced number of links. Other peripherals operating at high traffic levels are impacted by the loss of a single link. Peripherals operating at a moderate capacity may have no margin after the loss of a single link. FIG. 12 illustrates a further step in the recovery processes in data center 222, where some links are removed by the photonic switch control system from peripherals that are measured to be lightly loaded, and therefore can give up some capacity, which is then reassigned to high traffic or medium traffic peripherals based on need. In this particular example, 100% of high traffic peripherals have full connectivity, while 67% of moderately loaded peripherals have full connectivity. Low traffic peripherals have at least two links, which is likely sufficient capacity while they remain in a low traffic state. If the traffic load of the low traffic peripherals increases, the links may be readjusted at that time by the processes described earlier.

Hence, by operation of the photonic switch to rearrange junctor connections based upon the control system knowledge of the failure type and location, and the actual traffic loads/demands on each TOR, it is possible to substantially ameliorate the effects of the failure, especially restoring critical high traffic level peripherals to full capacity. Once this action has been completed, the ongoing real-time measurement of traffic loads and use of forecasts of upcoming traffic described earlier will continue to be applied so as to continue to minimize the impact of the equipment outage until such time as the failed equipment is restored to service.

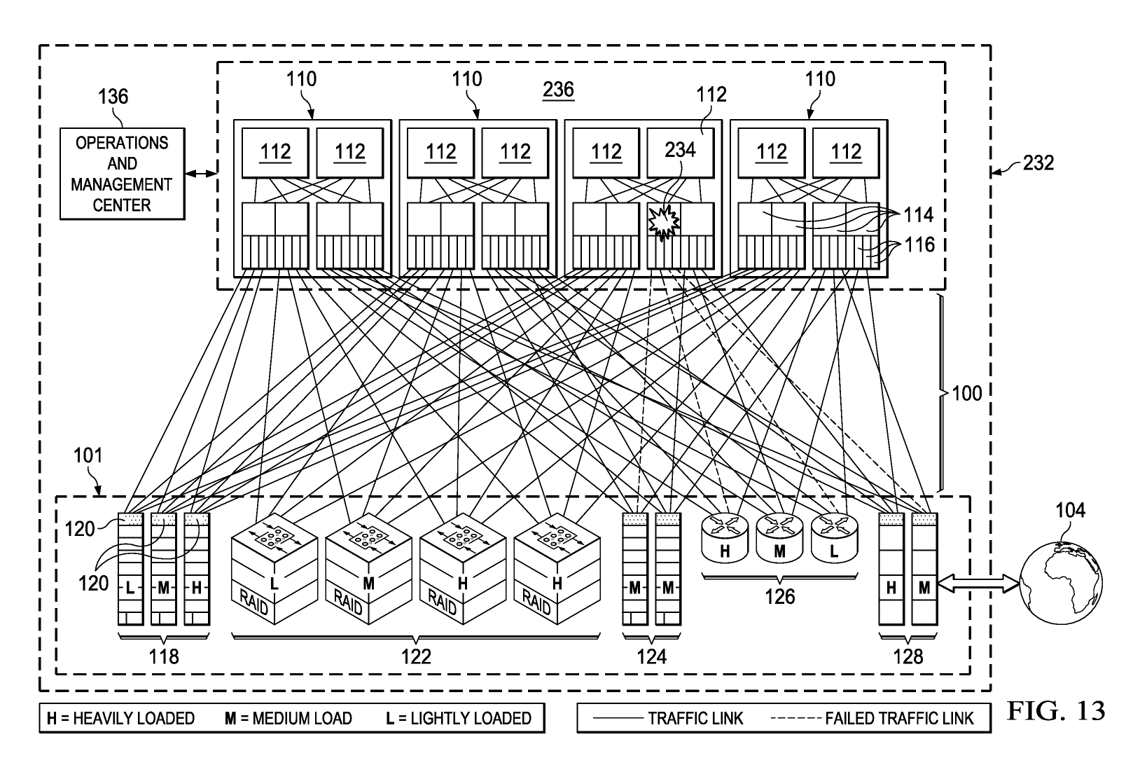

FIGS. 13-16 show the effects of an outage on one part of one core packet switch, without and with the photonic switching of links under control of the controller.

FIG. 13 illustrates data center 232 without a photonic switch and with failure 234 of failure 234 one quadrant of one packet switch, which impacts 1/16 of the core switching capacity. This failure only affects a few peripherals, each of which loses 25% of their capacity.

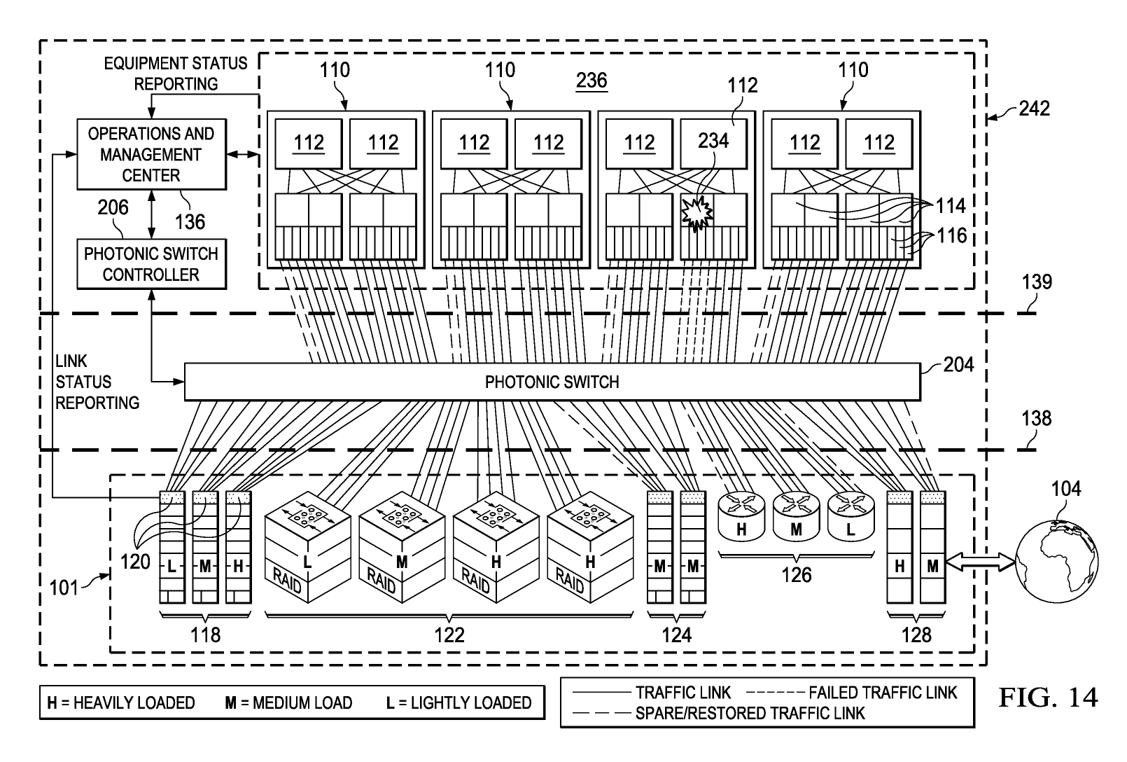

FIG. 14 illustrates data center 242 with photonic switch 204 and with failure 234 of one quadrant of one packet switch. There is sufficient spare capacity in data center 252 for all peripherals to maintain adequate capacity. Initially, the effect of the failure is the same as in data center 232. However, the failure is detected by packet switching core 236 and the peripherals affected by the failure. The failures are reported to OMC 136. Spare capacity is then deployed.

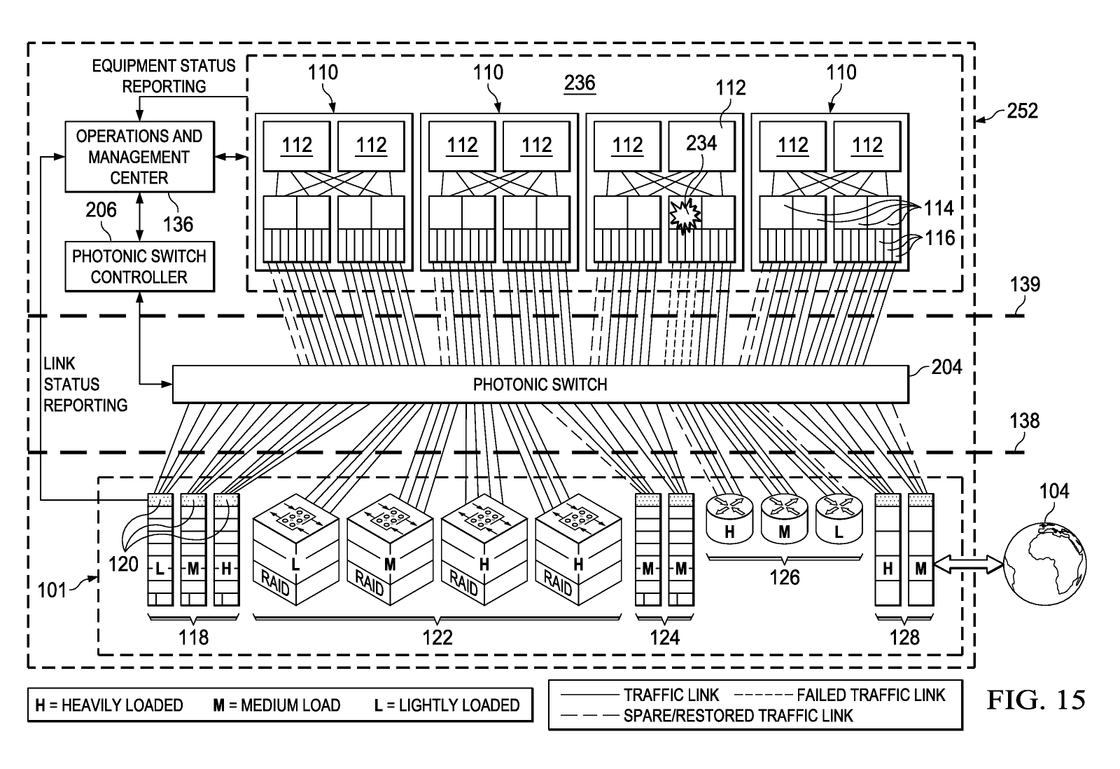

In this example, there is sufficient spare capacity to fully restore the link capacities of the affected peripherals, reducing the impact of the failure to zero. FIG. 15 illustrates data center 252, where the link capacity to the affected peripherals has been restored by the photonic switch controller operating photonic switch 204 to reconfigure the affected links.

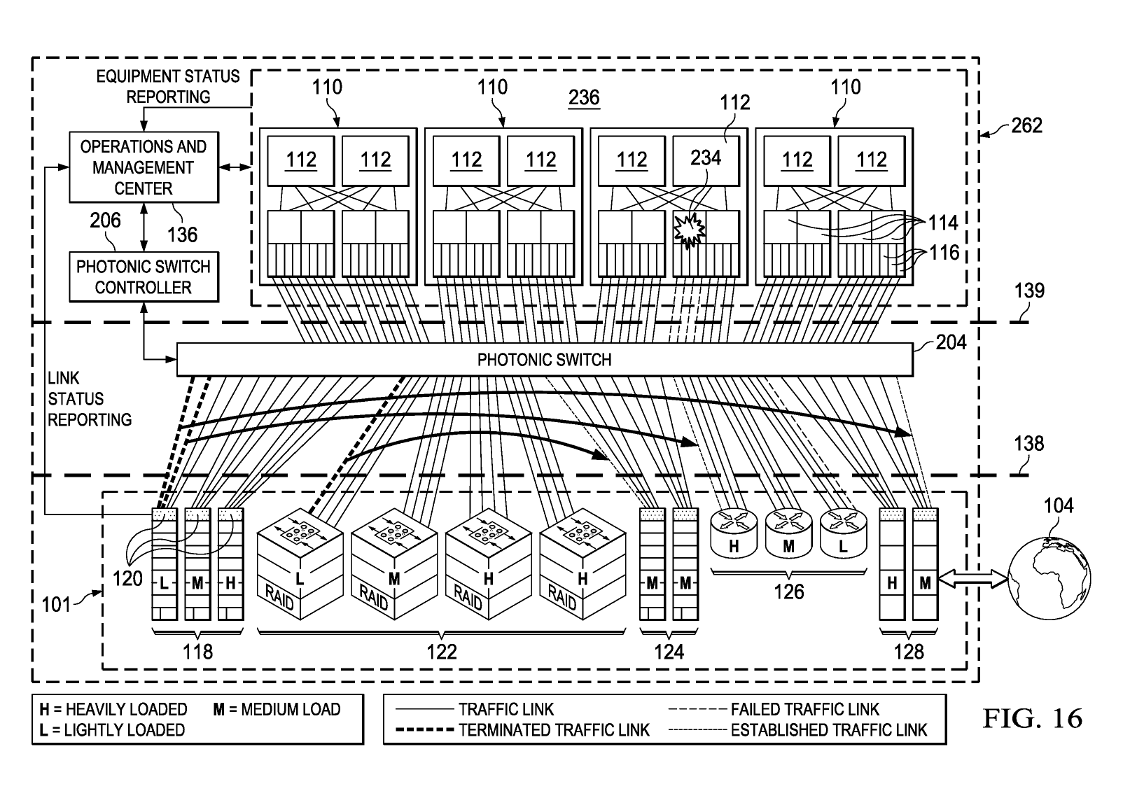

FIG. 16 illustrates data center 262 with failure 234 of one quadrant of one packet switch and photonic switch 204. Data center 262 does not have any spare capacity. In this case, OMC 136 moves links from low traffic peripherals outside the failure zone to high traffic capacity peripherals impacted by the failure. In this example, moderate and high traffic peripherals outside the zone of failure operate normally. Three low traffic peripherals see an impact on their port capacity, which is likely inconsequential since, as low traffic peripherals, they would not be fully utilizing that capacity. If the affected low traffic peripherals are subjected to an increase in traffic or are projected to require an increase in traffic due to time-of-day projections, they can be allocated additional links dynamically, with this process continuing until the failed switching unit is repaired and returned to service.

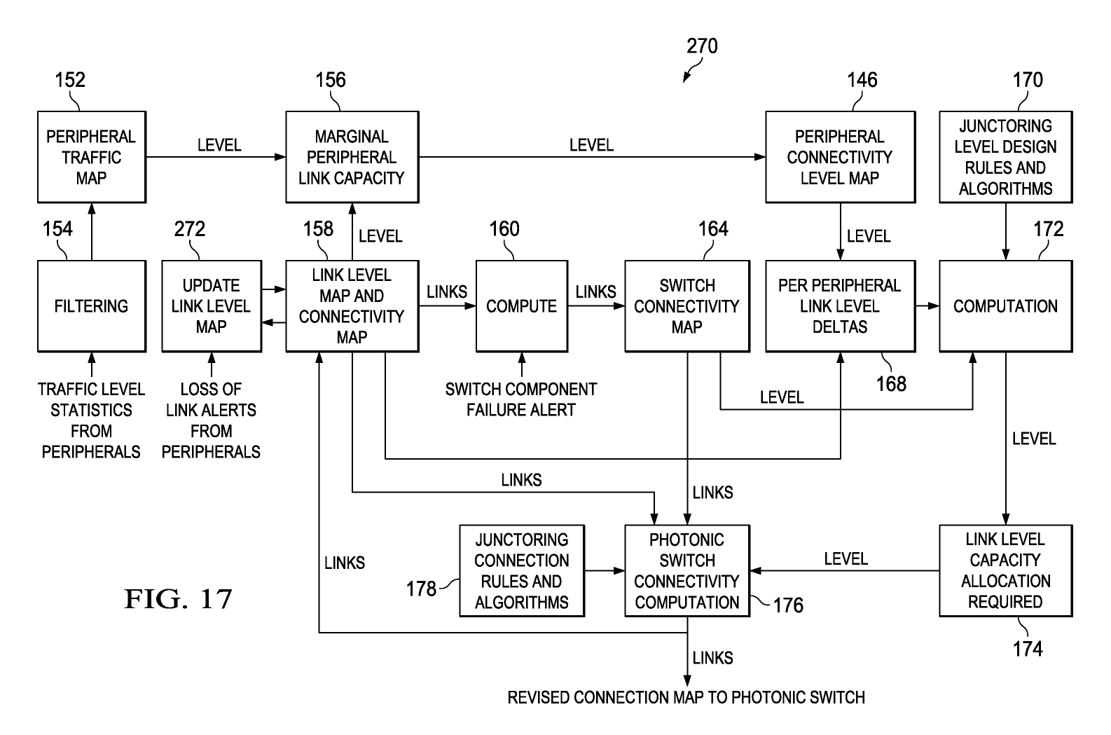

FIG. 17 illustrates control structure 270 which may be used as photonic switch controller 206 to recover from a packet switching core failure. Control structure 270 is similar to control structure 140. Control structure 270 has an input for a loss of link alert from peripherals. The loss of link alert is received by update link level map 272. For example, various levels of failures of the packet switching core may occur. A single port, a multi-port overall port card or module, or an entire packet switch may fail. Upon receiving a loss of link alert, update link level map 272 modifies a copy of the link level and connectivity map to indicate that the failed links are unavailable, before writing the revised map to link level and connectivity map 158. Link level and connectivity map 158 outputs the changes based on the revised map.

The peripherals associated with failed links automatically attempt to place the displaced traffic on other links, raising their occupancy. This increase is detected through the traffic measuring processing of filtering block 154, peripheral traffic map 152, and marginal peripheral link capacity block 156. These links are tagged as marginal capacity links if appropriate. More links are then allocated to relieve the congestion. The failed links are avoided, because they are now marked as unusable.

When the failure is caused by a significant packet switching core failure, for example the failure of an entire packet switch, all of the connections between the photonic switch and the failed packet switch are inoperative. A message identifying the scope of the failure is sent to link level and connectivity map 158. The failed links are marked as unserviceable, and are written into switch connectivity map 164. Meanwhile, the links between the peripherals and the photonic switch terminating on the failed packet switch fail to support traffic, and the peripherals will divert traffic to links to other packet switches, causing the occupancy of the these links to increase. This increase is detected by filtering block 154, peripheral traffic map 152, and marginal peripheral link capacity block 156. These links are tagged as marginal capacity links as appropriate.

In another example, a photonic switch inserted between a packet switching core and the peripherals in a data centers is used to power down components during low demand periods. The power of a large data center may cost many millions of dollars per year. In a power down scenario, some peripherals may also be powered down when demand is light. At the same time, core switching resources may be powered down. With a fixed mapping of peripherals to core switching resources, only the core switching resources that are connected to powered down peripherals can be powered down, limiting flexibility. When a photonic switch is between the peripherals and the packet switching core, the connections may be changed to keep powered up peripherals fully connected.

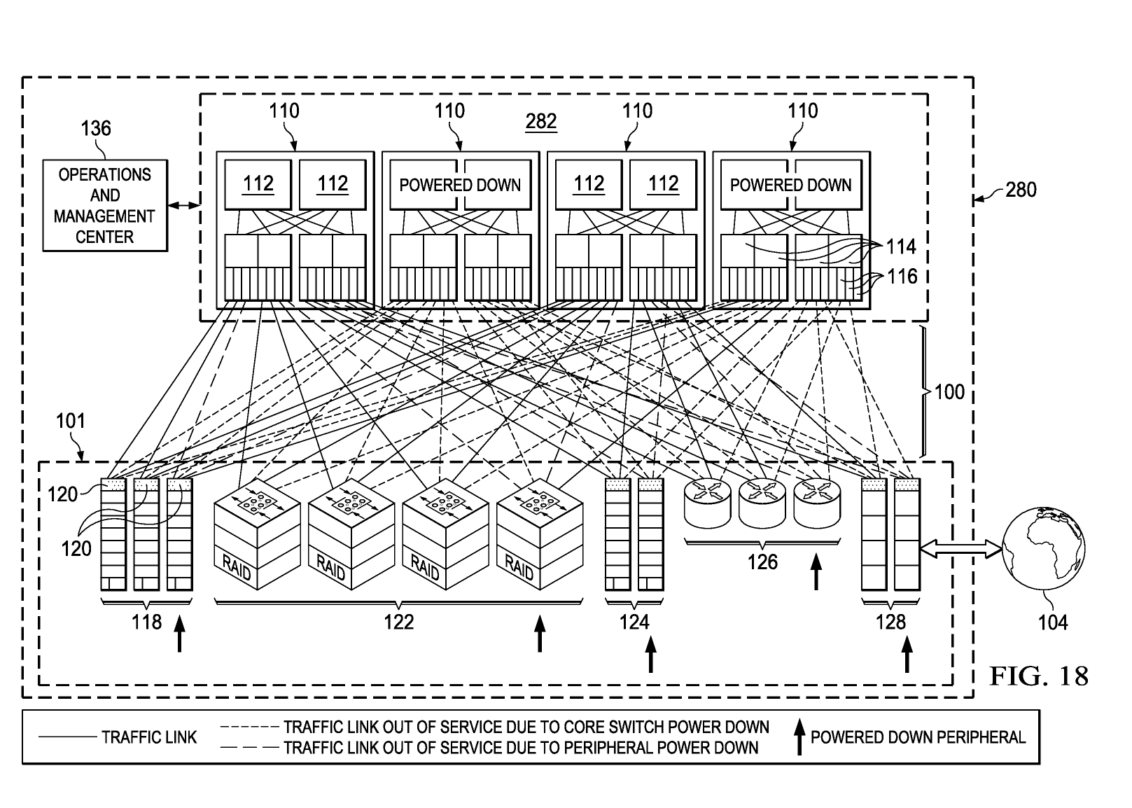

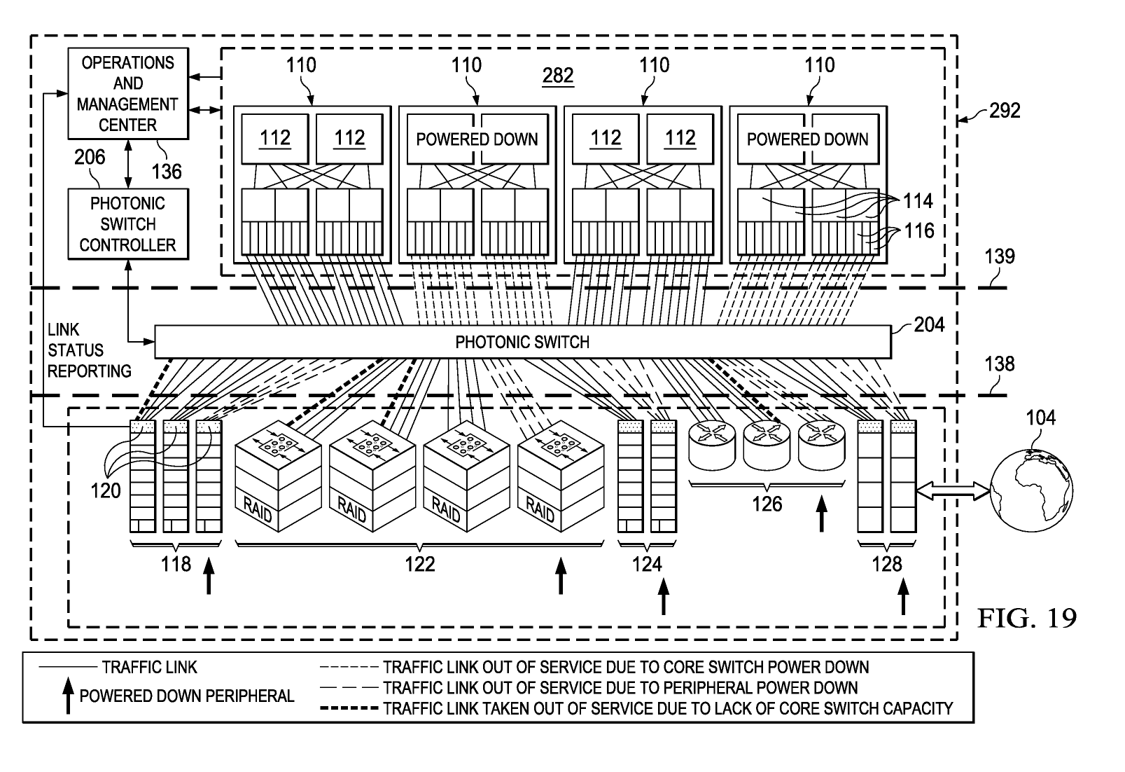

In data centers, while the core packet switch burns a lot of power, the peripherals burn even more. Hence, under light load conditions, it is common to power down some of the peripherals but not some of the core switching capacity, since powering down part of the core switch would affect the capacity of the remaining peripherals, some of which will be working at high capacity, having picked up the load of some powered down peripherals. This is caused by the fixed junctor pattern, which prevents powering down part of the core packet switch without reducing capacity to all peripherals. However, with an ability to reconfigure the switch-peripheral junctor pattern, this problem can be overcome. FIGS. 18 and 19 show data centers with powered down core packet switching segments in the cases of no photonic switching of links and controlled photonic switching of links respectively.

FIG. 18 illustrates data center 280, where some peripherals and some portions of packet switching core 282 are powered down. In a switching structure where an array of peripherals is switched by an array of switches, an orthogonal interconnect or junctoring is used to connect part of each peripheral's capacity to each part of the switch, and vice versa. This creates a structure with relatively evenly matched traffic handling capacities when all core packet switches are operating.

However, if peripherals and packet switching modules are deliberately powered down, as is shown in FIG. 18, this structure has some limitations. If X % of the packet switching modules is removed, for example by powering down during periods of light traffic, each peripheral loses X % of its link capacity, leaving (100−X) % of its interconnect capacity. If Y % of the peripherals are powered down, Y % of the links to the switching core are inoperative, and the node throughput is (100−Y) %. When the traffic in the data center is low enough to power down a significant percentage of the peripherals, it may also be desirable to power down a significant percentage of the packet switching modules. However, if X % of the switches and Y % of the peripherals are powered down, the remaining (100−Y) % of the peripherals see X % of their links removed, leaving (100−X) % of their overall capacity, for an overall capacity of (100−Y)(100−X) %. For example, removing 50% of the switch capacity and 50% of the peripheral capacity produces a reduction in the data center throughput to 25% of the original capacity. Table 3 below illustrates the effects of powering down the packet switching modules and peripherals.

TABLE 3

| | | % Of Peripherals That are Powered | | | | | | | | | |
|---|---|---|---|---|---|---|---|---|---|---|---|
| | | 100 | 90 | 80 | 70 | 60 | 50 | 40 | 30 | 20 | 10 |
| % Of | 100 | 100 | 90 | 80 | 70 | 60 | 50 | 40 | 30 | 20 | 10 |
| Switch | 90 | 90 | 81 | 72 | 63 | 54 | 45 | 36 | 27 | 18 | 9 |
| That Is | 80 | 80 | 72 | 64 | 56 | 48 | 40 | 32 | 24 | 16 | 8 |
| Powered | 75 | 75 | 67.5 | 60 | 52.5 | 45 | 37.5 | 30 | 22.5 | 15 | 7.5 |
| | 70 | 70 | 63 | 56 | 49 | 42 | 35 | 28 | 21 | 14 | 7 |
| | 60 | 60 | 54 | 48 | 42 | 36 | 30 | 24 | 18 | 12 | 6 |
| | 50 | 50 | 45 | 40 | 35 | 30 | 25 | 20 | 15 | 10 | 5 |
| | 40 | 40 | 36 | 32 | 28 | 24 | 20 | 16 | 12 | 8 | 4 |
| | 30 | 30 | 27 | 24 | 21 | 18 | 15 | 12 | 9 | 6 | 3 |
| | 25 | 25 | 22.5 | 20 | 17.5 | 15 | 12.5 | 10 | 7.5 | 5 | 2.5 |
| | 20 | 20 | 18 | 16 | 14 | 12 | 10 | 8 | 6 | 4 | 2 |
| | 10 | 10 | 9 | 8 | 7 | 6 | 5 | 4 | 3 | 2 | 1 |

The compounding of the lost capacity arises because the fixed junctoring pattern leaves some ports of each powered on packet switching module and some ports on each powered up peripheral stranded when partial powering down occurs. Because peripherals generally take more power than the packet switching modules supporting them, the peripherals only may be powered down, and not the switching capacity. For example, if a data center load enables its capacity to be reduced to 40% of its maximum capacity, 60% of the peripherals and none of the packet switching modules may be powered down, 60% of the packet switching modules and none of the peripherals may be powered down, 50% of the peripherals and 20% of the packet switching modules may be powered down, or 40% of the peripherals and 30% of the packet switching modules may be powered down. Because peripherals utilize more power than the packet switching modules, it makes sense to power down 60% of the peripherals and none of the packet switching modules.

FIG. 19 illustrates data center 292 with photonic switch 204 where some peripherals and some switching core modules are powered down. The junctoring pattern is controlled through connections in photonic switch 204, and can be reset. The powered-up packet switching modules and peripherals may be fully used or used.

In the example in data center 292, more packet switching capacity is removed than peripheral capacity, so the remaining powered on peripherals see a small reduction in capacity. If the reduction in packet switching capacity is less than the reduction in peripheral capacity, the peripherals would see no loss of connectivity. Table 4 below illustrates the relationship between the data center capacity and the percentage of packet switching capacity and peripheral capacity removed.

TABLE 4

| | | % Of Peripherals That are Powered | | | | | | | | | |
|---|---|---|---|---|---|---|---|---|---|---|---|
| | | 100 | 90 | 80 | 70 | 60 | 50 | 40 | 30 | 20 | 10 |
| % Of | 100 | 100 | 90 | 80 | 70 | 60 | 50 | 40 | 30 | 20 | 10 |
| Switch | 90 | 90 | 90 | 80 | 70 | 60 | 50 | 40 | 30 | 20 | 10 |
| That Is | 80 | 80 | 80 | 80 | 70 | 60 | 50 | 40 | 30 | 20 | 10 |
| Powered | 75 | 75 | 75 | 75 | 70 | 60 | 50 | 40 | 30 | 20 | 10 |
| | 70 | 70 | 70 | 70 | 70 | 60 | 50 | 40 | 30 | 20 | 10 |
| | 60 | 60 | 60 | 60 | 60 | 60 | 50 | 40 | 30 | 20 | 10 |
| | 50 | 50 | 50 | 50 | 50 | 50 | 50 | 40 | 30 | 20 | 10 |
| | 40 | 40 | 40 | 40 | 40 | 40 | 40 | 40 | 30 | 20 | 10 |
| | 30 | 30 | 30 | 30 | 30 | 30 | 30 | 30 | 30 | 20 | 10 |
| | 25 | 25 | 25 | 25 | 25 | 25 | 25 | 25 | 25 | 20 | 10 |
| | 20 | 20 | 20 | 20 | 20 | 20 | 20 | 20 | 20 | 20 | 10 |
| | 10 | 10 | 10 | 10 | 10 | 10 | 10 | 10 | 10 | 10 | 10 |

The resulting capacity improvement is illustrated in Table 5. The same percentage of packet switching capacity and peripheral capacity may be powered down with no excess loss of capacity.

TABLE 5

| | | % Of Peripherals That are Powered | | | | | | | | | |
|---|---|---|---|---|---|---|---|---|---|---|---|
| | | 100 | 90 | 80 | 70 | 60 | 50 | 40 | 30 | 20 | 10 |
| % Of | 100 | 1.00 | 1.00 | 1.00 | 1.00 | 1.00 | 1.00 | 1.00 | 1.00 | 1.00 | 1.00 |
| Switch | 90 | 1.00 | 1.11 | 1.11 | 1.11 | 1.11 | 1.11 | 1.11 | 1.11 | 1.11 | 1.11 |
| That Is | 80 | 1.00 | 1.11 | 1.25 | 1.25 | 1.25 | 1.25 | 1.25 | 1.25 | 1.25 | 1.25 |
| Powered | 75 | 1.00 | 1.11 | 1.25 | 1.33 | 1.33 | 1.33 | 1.33 | 1.33 | 1.33 | 1.33 |
| | 70 | 1.00 | 1.11 | 1.25 | 1.43 | 1.43 | 1.43 | 1.43 | 1.43 | 1.43 | 1.43 |
| | 60 | 1.00 | 1.11 | 1.25 | 1.43 | 1.67 | 1.67 | 1.67 | 1.67 | 1.67 | 1.67 |
| | 50 | 1.00 | 1.11 | 1.25 | 1.43 | 1.67 | 2.00 | 2.00 | 2.00 | 2.00 | 2.00 |
| | 40 | 1.00 | 1.11 | 1.25 | 1.43 | 1.67 | 2.00 | 2.50 | 2.50 | 2.50 | 2.50 |
| | 30 | 1.00 | 1.11 | 1.25 | 1.43 | 1.67 | 2.00 | 2.50 | 3.33 | 3.33 | 3.33 |
| | 25 | 1.00 | 1.11 | 1.25 | 1.43 | 1.67 | 2.00 | 2.50 | 3.33 | 4.00 | 4.00 |
| | 20 | 1.00 | 1.11 | 1.25 | 1.43 | 1.67 | 2.00 | 2.50 | 3.33 | 5.00 | 5.00 |
| | 10 | 1.00 | 1.11 | 1.25 | 1.43 | 1.67 | 2.00 | 2.50 | 3.33 | 5.00 | 10.00 |

Control structure 270 may be used as photonic switch controller 206, where the inputs are associated with the intent to power down rather than failures. The changes in the link structure may be pre-computed before the power down rather than reacting to a failure.

In another embodiment, a photonic switch inserted into a data center between the peripherals and the packet switching core may be used for operations and maintenance of components, such as the peripherals and/or the packet switching core. The components may be taken out of service, disconnected by the photonic switch, and connected to alternative resources, such as a test and diagnostics system, for example using spare ports on the photonic switch. This may be performed on a routine cyclic basis to validate peripherals or packet switching modules, or in response to a problem to be diagnosed. This may also be done to carry out a fast backup of a peripheral before powering down that peripheral. It may be triggered, for example, by triggering a C-through massive backup or to validate that a peripheral has properly powered up before connecting it.

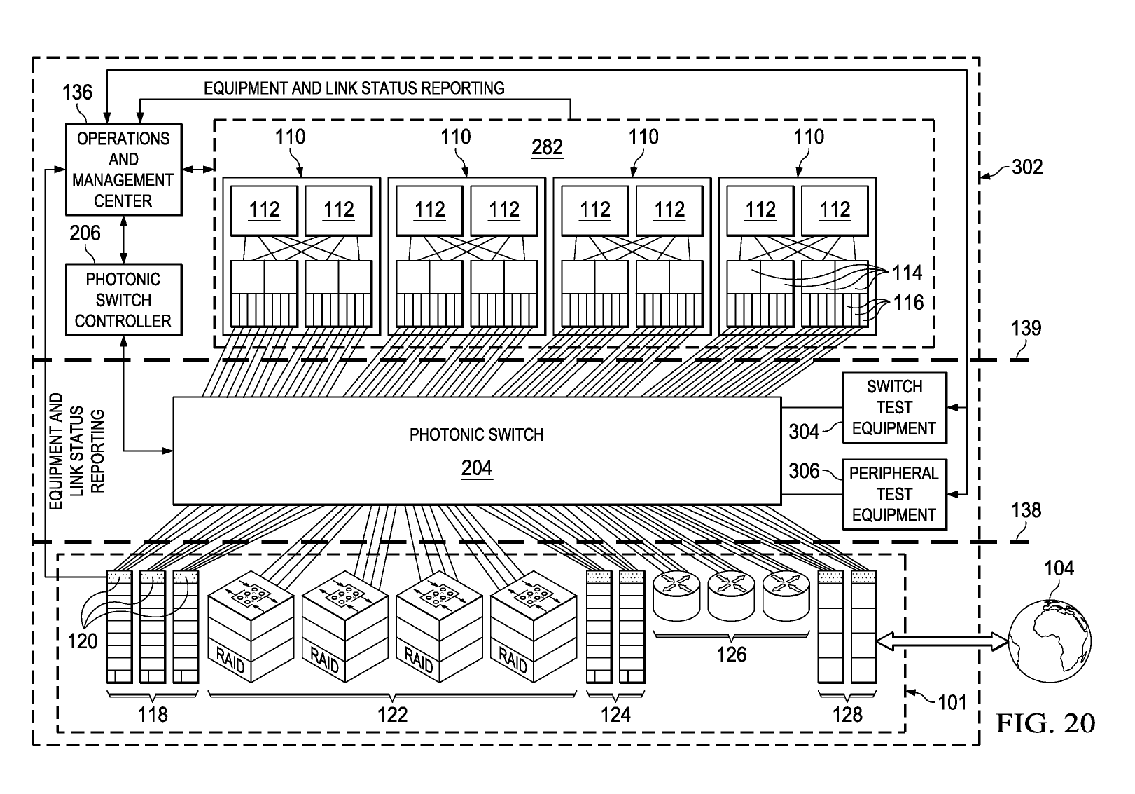

FIG. 20 illustrates data center 302 with photonic switch 204 interfaced to switch test equipment 304 and peripheral test equipment 306. The peripheral or packet switching module is connected to the switch test equipment 304 or peripheral test equipment 306 based on OMC 136 commanding photonic switch controller 206 to set up the appropriate connections in photonic switch 204. Then, the test equipment is controlled, and data is gathered from the equipment via data links between the test equipment and OMC 136.

In one instantiation, when the controller function of FIG. 17 completes the reassignment of traffic after a failure has occurred, it may connect those switch ports or peripheral ports which have been disconnected/have reported failures to the test modules 304 and 306 in FIG. 20.

Such a testing setup may be used in a variety of situations. When components, such as a packet switching module or a peripheral is detected as being faulty, that components it can be taken out of service and connected to the appropriate test equipment to characterize or diagnose the fault. Before a new, replacement, or repaired component is put into service, it may be tested for proper operation by the test equipment to ensure proper functionality. After a packet switching module or peripheral has been powered down for a period of time, it may be tested on power up to ensure proper functionality before being reconnected to the data center. The freshly powered up devices may receive an update, such as new server software, before being connected to the data center.

In another example, a photonic switch may facilitate the expansion of a data center. As data center traffic grows, additional peripherals and packet switching capacity may be added. This additional capacity may be commissioned, and the data center is reconfigured to integrate the new components more rapidly and efficiently, with fewer disruptions, if the new items are connected to the old items via a photonic switch. Also, the old components may be reconfigured more rapidly using a photonic switch.

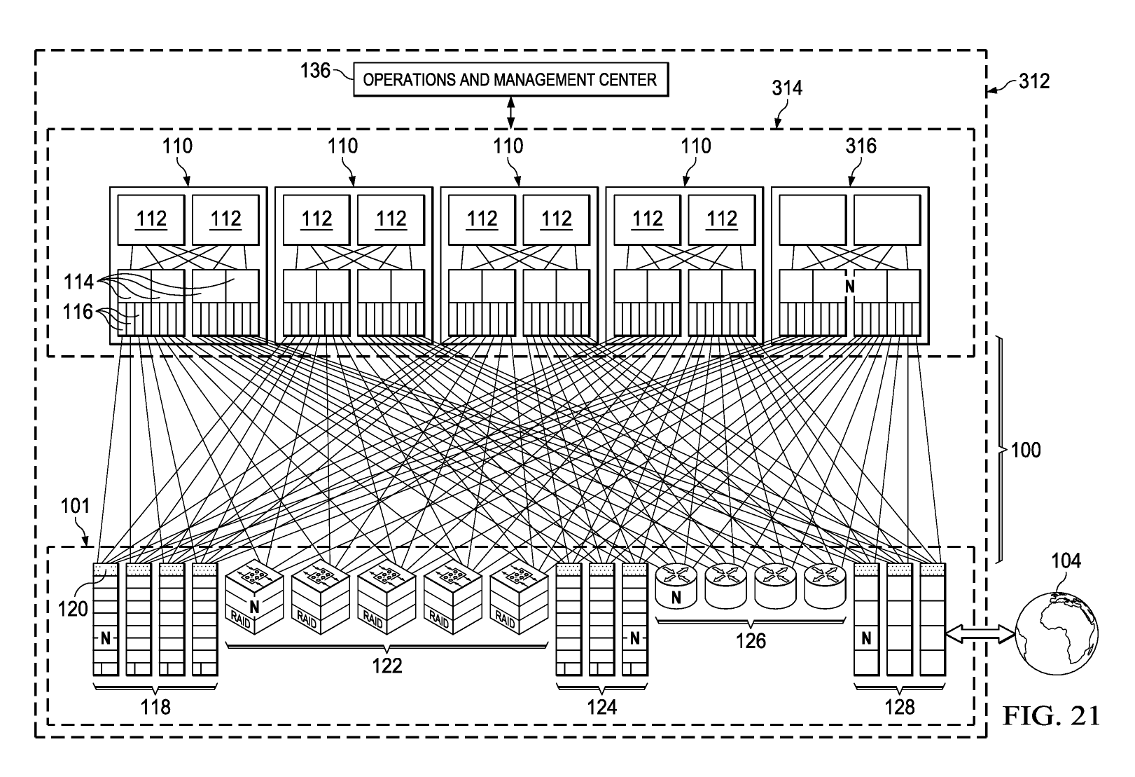

FIG. 21 illustrates data center 312 where peripherals and switching capacity are added without the use of a photonic switch. The switching capacity is expanded by about 25% by adding a fifth parallel packet switch 316. Also, several new peripherals, labeled “N” have been added. Because the new peripherals and switches should be able to communicate with the pre-existing switches and peripherals, the new peripherals and switches should have some of their links going to pre-existing switches and peripherals respectively. This results in a massive rework of the junctoring connections, which are done manually. This process is disruptive, time consuming, error prone, and expensive. Because of these difficulties, a sub-optimal junctoring pattern may be set up to avoid excessive reconfiguration costs, leading to problems as traffic grows, such as traffic congestion, or blockage between specific peripherals and switch elements.

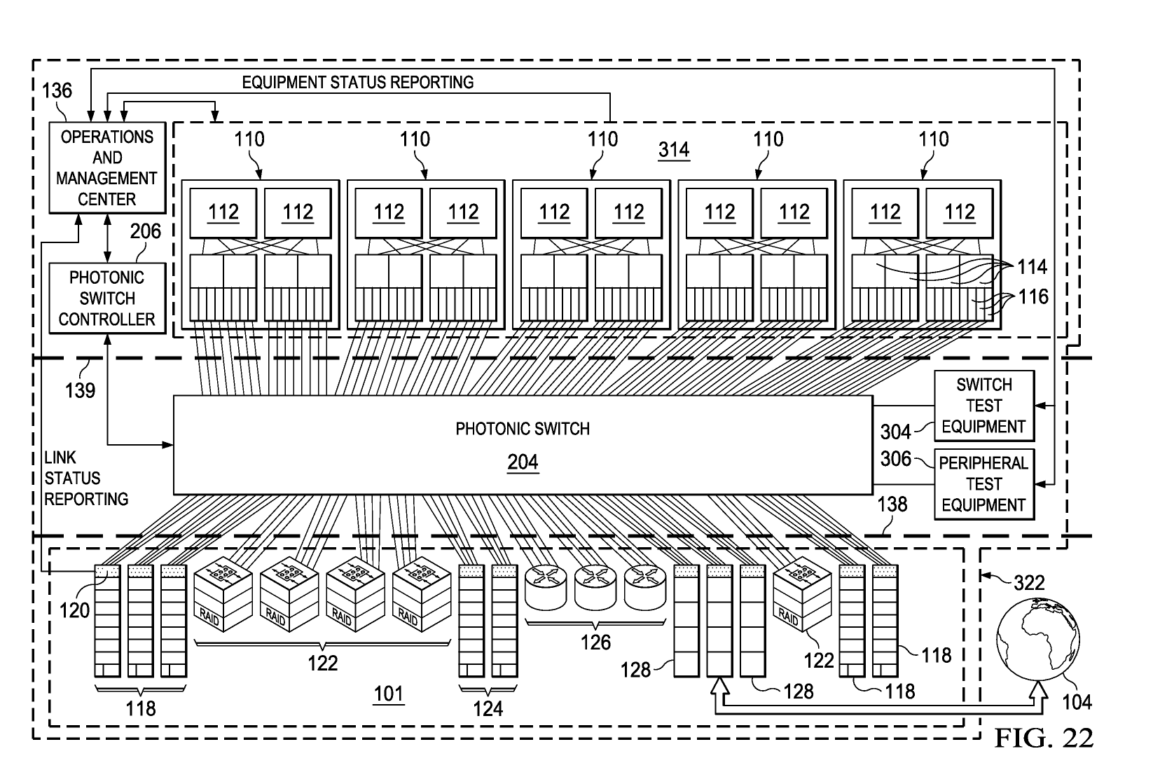

FIG. 22 illustrates data center 322 with photonic switch 204 for adding peripherals and packet switching capacity. Packet switching core 314 has been expanded by adding an additional switch and with new peripherals—shown at the right side of FIG. 22. Photonic switch 204 may or may not need to be expanded. The high speed short reach optical links from the new packet switch and the new peripherals are simply connected to ports on photonic switch 204, and a new junctoring pattern is set up by OMC 136 photonic switch controller 206 adjusting connections in photonic switch 204. The new components may be tested using test equipment, such as switch test equipment 304 and peripheral test equipment 306, before being placed into service.

In an additional example, a photonic switch facilitates the integration of dissimilar components. Data centers involve massive investments of money, equipment, real estate, power, and cooling capabilities, so it is desirable to exploit this investment for as long as possible. Technology of components of data centers rapidly evolve. As a data center ages, it might be viable, but as a result of traffic growth, it may need expansion. It may be beneficial to expand with new rather than previous generation technology, which may be obsolete, if the new and old technology can operate together. This may be the case when the junctoring pattern of the data center interconnect enables all components to connect to all other components.

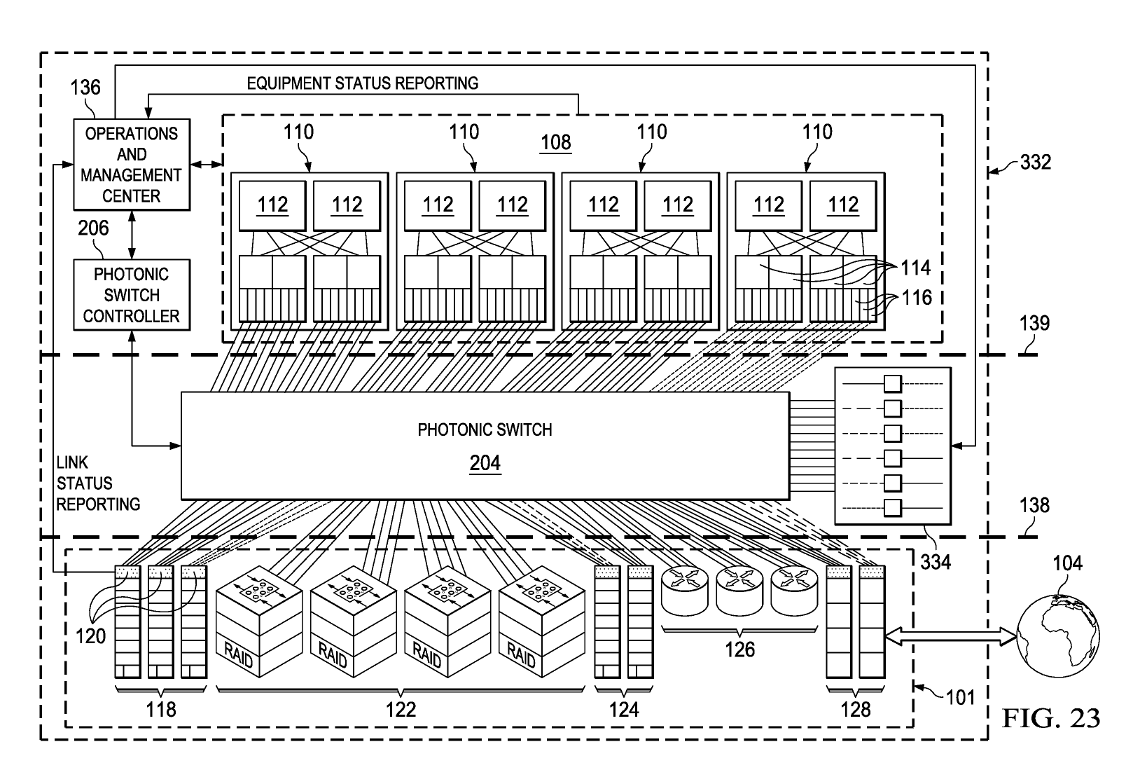

One common change in new technology is the interconnection speed. For example, the original data center components may be based on short reach 40 Gb/s optical links, while the new components might be optimized for 100 Gb/s operation, and may not have a 40 Gb/s interface. FIG. 23 illustrates data center 332 which facilitates integration of new devices by exploiting the format, protocol, and bit rate independence of photonic switch 204. Also, spare ports of photonic switch 204 are connected to adaptors 334 for rate conversion, protocol conversion, and other conversions for compatibility.

Data center 332 contains two different switching core formats, illustrated by solid black and solid gray lines, and four different peripheral formats, illustrated by solid black, solid gray, dotted black, and dotted gray lines. For example, a solid black line may indicate a 40 Gb/s link, while a solid gray line indicates a 100 Gb/s link. Connections between links with the same bit rate may be made without using a bit rate converter, because photonic switch 204 is bit rate, format, protocol, and wavelength agnostic. However, a bit rate converter is used when links of different bit rates are connected.

The conversion may be performed in a variety of ways depending on the nature of the conversion. For example, the optical wavelength, bit rate, modulation or coding schemes, mapping levels, such as internet protocol (IP) to Ethernet mapping, address conversion, packet formats, and/or structure conversion may be performed.

A photonic switch in a data center between a packet switching core and peripherals should be a large photonic switch. A large photonic switch may be a multi-stage switch, such as a CLOS switch, which uses multiple switching elements in parallel. The switch may contain a complex junctoring pattern between stages to create blocking, conditionally non-blocking, or fully non-blocking fabrics. A non-blocking multi-stage fabric uses a degree of dilation in the center stage, for example from n to 2n01, where n is the number of ports on the input of each input stage switching module.

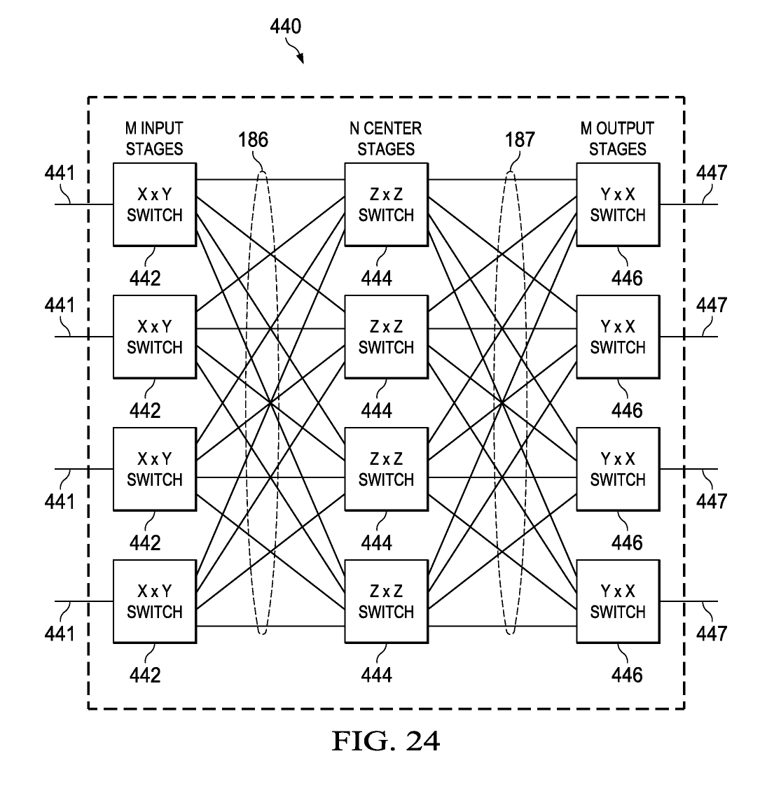

FIG. 24 illustrates CLOS switch 440, a three stage CLOS switch fabricated from 16×16 photonic switches. CLOS switch 440 contains inputs 441, which are fed to input stage fabrics 442, X by Y switches. Junctoring pattern of connections 186 connects input stage fabrics 442 and center stage fabrics 444, Z by Z switches. X, Y, and Z are positive integers. Also, junctoring pattern of connections 187 connects center stage fabrics 444 and output stage fabrics 446, Y by X switches to connect every fabric in each stage equally to every fabric in the next stage of the switch. Output stage fabrics 446 produce outputs 447. Four input stage fabrics 442, center stage fabrics 444, and output stage fabrics 446 are pictured, but fewer or more stages or fabrics per stage may be used. In an example, there are the same number of input stage fabrics 442 and output stage fabrics 446, with a different number of center stage fabrics 444, where Z is equal to Y times the number of input stages divided by the number of center stages. The effective port count of CLOS switch 440 is equal to the number of input stage fabrics multiplied by X by the number of output stage fabrics multiplied by X. In an example, Y is equal to 2X−1, and CLOS switch 440 is non-blocking. In another example, X is equal to Y, and CLOS switch 440 is conditionally non-blocking. A non-blocking switch is a switch that connects N inputs to N outputs in any combination irrespective of the traffic configuration on other inputs or outputs. A similar structure can be created with 5 stages for larger fabrics, with two input stages in series and two output stages in series.

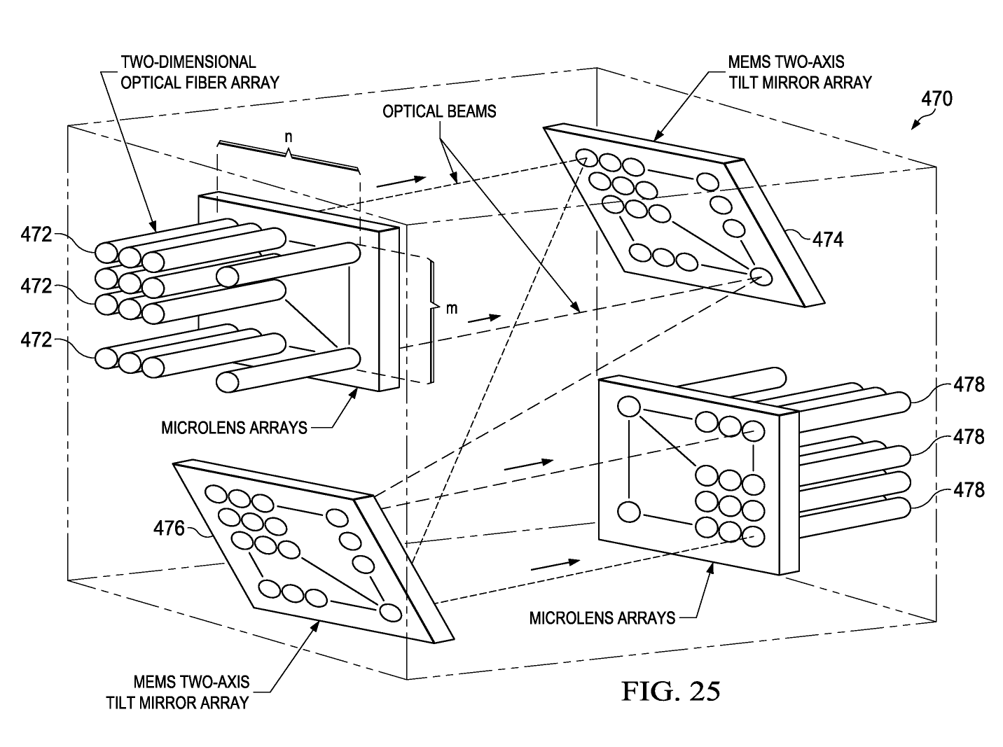

A micro-electro-mechanical-system (MEMS) switch may be used in a data center. FIG. 25 illustrates MEMS photonic switch 470. The switching speed of MEMS photonic switch 470 may be from about 30 ms to almost 100 ms. While this slow switching speed is too slow for many applications, a photonic switch used to manage junctoring patterns in response to averaged traffic changes and equipment outages or reconfigurations/additions in a data center does not need to have a particularly fast switching speed in order to be useful, although a fast speed will improve recovery time somewhat. This is due to the fact that the switching time is in series with the fault detection analysis and processing times or the traffic analysis detection. The processing times take a finite length of time and/or may be predictions. In addition, enough capacity is retained so that short period traffic bursts can be handled by the excess provisioned capacity (the 2-3 standard deviations) combined with buffering and flow control at the TCP/IP layer. However for some applications, notably fault detection and recovery, as fast as possible photonic switching is desirable.

MEMS photonic switch 470 also has excellent optical performance, including a low loss, virtually no crosstalk, polarization effects or nonlinearity, and the ability to handle multi-carrier optical signals. In one example, MEMS photonic switch 470 is used alone. In another example, a MEMS photonic switch 470 is used in CLOS switch 440 or another multi-stage fabric. This may enable non-blocking switches of 50,000 by 50,000 or more fibers. Optical amplifiers may be used with MEMS photonic switch 470 to offset optical loss. MEMS photonic switch 470 contains steerable mirror planes 474 and 476. Light enters via beam collimator 472, for example from optical fibers, and impinges on steerable mirror plane 474. Steerable mirror plane 474 is adjusted in angle in two planes to cause the light to impinge on the appropriate mirrors of steerable mirror plane 476. The mirrors of steerable mirror plane 476 are associated with a particular output port. These mirrors are also adjusted in angle in two planes to cause coupling to the appropriate output port. The light then exits in a beam expander 478, for example to optical fibers.

In one example, MEMS switches are arranged as multi-stage switches, such as CLOS switch 440. A three stage non-blocking MEMS switch may have 300 by 300 MEMS switching modules, and provide around 45,000 wavelengths in a dilated non-blocking structure or 090,000 in an undilated conditionally non-blocking structure. Table 6 below illustrates the scaling of the maximum switch fabric sizes for various sizes of constituent models with MEMS photonic switches with a 1:2 dilation for a non-blocking switch. Very high port capacities and throughputs are available.

TABLE 6

| | | | | | Throughput at | Throughput at |
|---|---|---|---|---|---|---|
| MEMS Module | Input Stage | Center Stage | Output Stage | Overall Fabric Port | 40 Gb/s per | 100 Gb/s per |
| Capacity | Module Size | Module Size | Module Size | Capacity | Port (Tb/s | Port (Tb/s) |
| 100 × 100 | 50 × 100 | 100 × 100 | 100 × 50 | 5,000 × 5,000 | 200 | 500 |
| 200 × 200 | 100 × 200 | 200 × 200 | 200 × 100 | 20,000 × 20,000 | 800 | 2,000 |
| 300 × 300 | 150 × 300 | 300 × 300 | 300 × 150 | 45,000 × 45,000 | 1,800 | 4,500 |
| 400 × 400 | 200 × 400 | 400 × 400 | 400 × 200 | 80,000 × 80,000 | 3,200 | 8,000 |
| 500 × 500 | 250 × 500 | 500 × 500 | 500 × 250 | 125,000 × 125,000 | 5,000 | 12,500 |
| 600 × 600 | 300 × 600 | 600 × 600 | 600 × 300 | 180,000 × 180,000 | 7,200 | 18,000 |
| 700 × 700 | 350 × 700 | 700 × 700 | 700 × 350 | 245,000 × 245,000 | 9,800 | 24,500 |
| 800 × 800 | 400 × 800 | 800 × 800 | 800 × 400 | 320,000 × 320,000 | 12,800 | 32,000 |
| 900 × 900 | 450 × 900 | 900 × 900 | 900 × 450 | 405,000 × 405,000 | 16,200 | 40,500 |
| 1,000 × 1,000 | 500 × 1,000 | 1,000 × 1,000 | 1,000 × 500 | 500,000 × 500,000 | 20,000 | 50,000 |

In another example, MEMS switches are arranged as multi-plane switches. Multi-plane switches rely on the fact that the transport layer being switched is in a dense WDM (DWDM) format and that optical carriers of a given wavelength can only be connected to other ports that accept the same wavelength, or to add, drop, or wavelength conversion ports. This enables a switch to be built up from as many smaller fabrics as there are wavelengths. With DWDM, there may be 40 or 80 wavelengths, allowing 40 or 80 smaller switches to do the job of one large fabric.

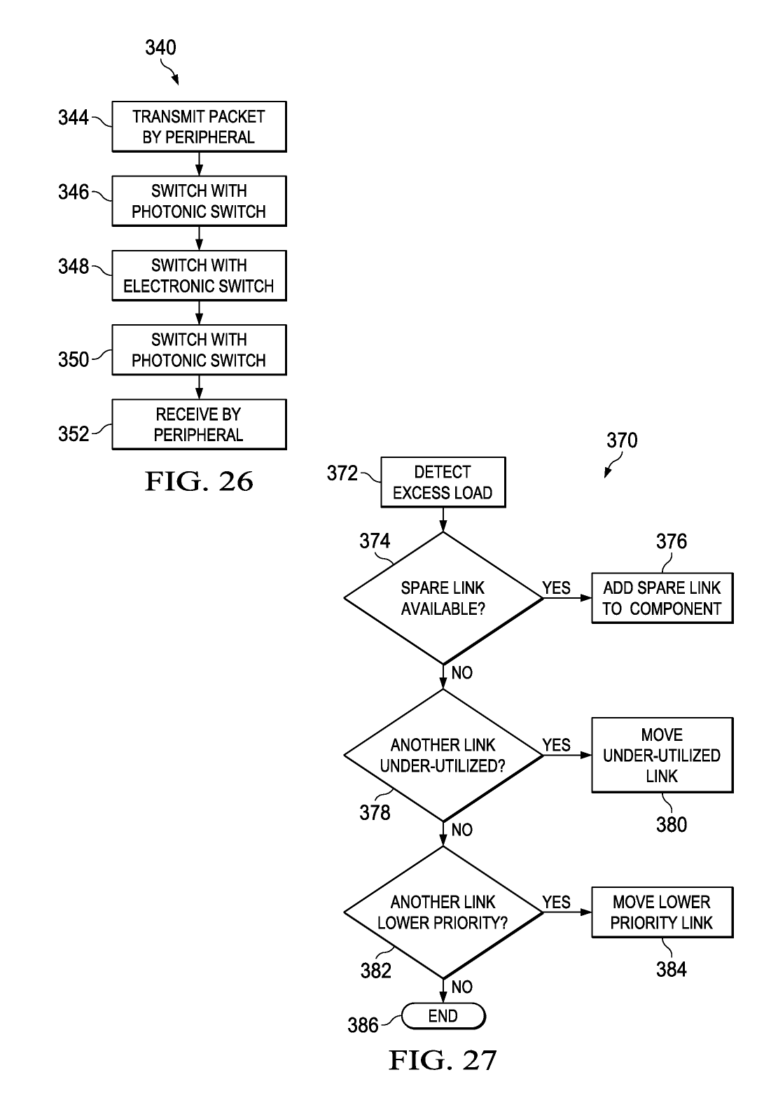

FIG. 26 illustrates flowchart 340 for a method of linking peripherals and a packet switching core in a data center. Initially, in step 344, a peripheral transmits one or more packets to a photonic switch. The packet may be optically transmitted along a fixed optical link.

Next, in step 346, the photonic switch directs the packet to the appropriate portion of the packet switching core. An appropriate connection between an input of the photonic switch and an output of the photonic switch is already set. The packet is transmitted on a fixed optical link to the desired portion of the packet switching core.

In step 348, the packet switching core switches the packet. The switched packet is transmitted back to the photonic switch along another fixed optical link.

Then, in step 350, the photonic switch routes the packet to the appropriate peripheral. The packet is routed from a connection on an input port to a connection on an output port of the photonic switch. The connection between the input port and the output port is pre-set to the desired location. The packet is transmitted on a fixed optical link to the appropriate peripheral.

Finally, in step 352, the packet is received by a peripheral.

FIG. 27 illustrates flowchart 370 for a method of adjusting links in a data center using a photonic switch. Initially, in step 372, the data center detects an excess load on a link from a component. In one example the component is a peripheral. In another example the component is a packet switching module. The excess load may be detected dynamically in real time. Alternatively, the excess load is determined based on a schedule, for example based on historical traffic loads.

Next in step 374, the data center determines if there is an available spare link. When there is an available spare link, the spare link is added to reduce the congestion in step 376.

When a spare link is not available, in step 378, the data center determines if there is an available link that is under-utilized. When there is an available link that is under-utilized, that link is transferred to reduce the congestion of the overloaded link in step 380.

When there is not an available link that is under-utilized, the data center, in step 382, determines if there is another lower priority link available. When there is another lower priority link, that lower priority link is transferred in step 384. When there is not a link to a lower priority component, the method ends in step 386.

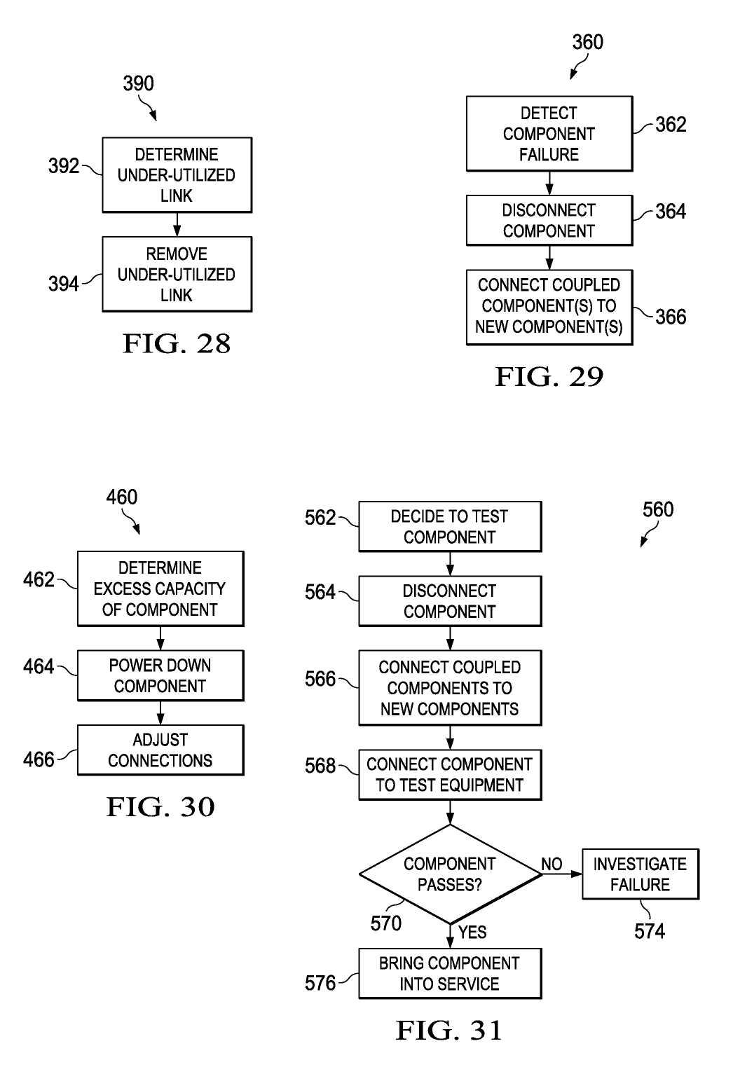

FIG. 28 illustrates flowchart 390 for a method of removing an under-utilized link in a data center using a photonic switch. Initially, in step 392, the underutilized link is determined. In one example, the under-utilized link is detected dynamically in real time. In another example, the under-utilized link is determined based on a schedule, for example based on historical data. Both peripheral links and packet switching core links may be under-utilized at the same time, for example in the middle of the night, or other times of low traffic.

Next, in step 394, the under-utilized link is removed. Other links between the component and the photonic switch will be sufficient to cover the traffic formerly transmitted by the under-utilized link. The removed link is then moved to spare capacity. If the links to this component later become over-utilized, the removed link may readily be added at that time. The spare link may also be used for other purposes.

FIG. 29 illustrates flowchart 360 for a method of addressing component failures in a data center using a photonic switch. Initially, in step 362, the component failure is detected. The failed component may be one or more packet switching modules, one or more peripherals, or a portion of a peripheral or packet switching module.

In step 364, the failed component is disconnected. The failed component may then be connected to test equipment to determine the cause of the failure.

Finally, in step 366, the components previously connected to the failed component are connected to another component that is still operational. The reconnection may be performed, for example, using steps 374-386 of flowchart 370.

FIG. 30 illustrates flowchart 460 for a method of powering down components in a data center with a photonic switch. Initially, in step 462, the data center determines excess capacity of a component. A large excess capacity should be determined for a component to be powered down. The component to be powered down may be a peripheral and/or the packet switching module.

Then, in step 464, the component is powered down. Links from the powered down component are removed, and placed in the unused link pool.

In step 466, components that were connected to the powered down component are disconnected, and unused links are placed in the excess capacity. As necessary, the component will be reconnected to other components. In some cases, some of the connected components are also powered down.

FIG. 31 illustrates flowchart 560 for a method of testing a component in a data center using a photonic switch. The component may be a peripheral or a packet switching module. Initially, in step 562, the data center decides to test a component. In one example, the component is tested due to a detected failure, such as an intermittent failure, or a complete failure. In another example, the component is tested for routing scheduled maintenance. This may be performed at a time of low traffic, for example in the middle of the night.

Then, in step 564, the component is disconnected from the component it is connected to. This is performed by adjusting connections the photonic switch.

In step 566, the disconnected component may be connected to another component, based on its need. Also, in step 568, the component to be tested is connected to test equipment, for example automated test equipment. There may be different test equipment for packet switching modules and various peripherals. Step 568 may be performed before step 566 or after step 566.

Next, in step 570, the component is tested. The testing is performed by the test equipment the component is connected to. When the component fails, the failure is further investigated in step 574. There may be further testing of the component, or the component may be repaired. Alternatively, the component is taken out of service. When the component passes, it is brought back into service in step 576. The component is connected to other components, and the links are re-adjusted for balancing. Alternatively, when the component passes, it is powered down until it is needed.

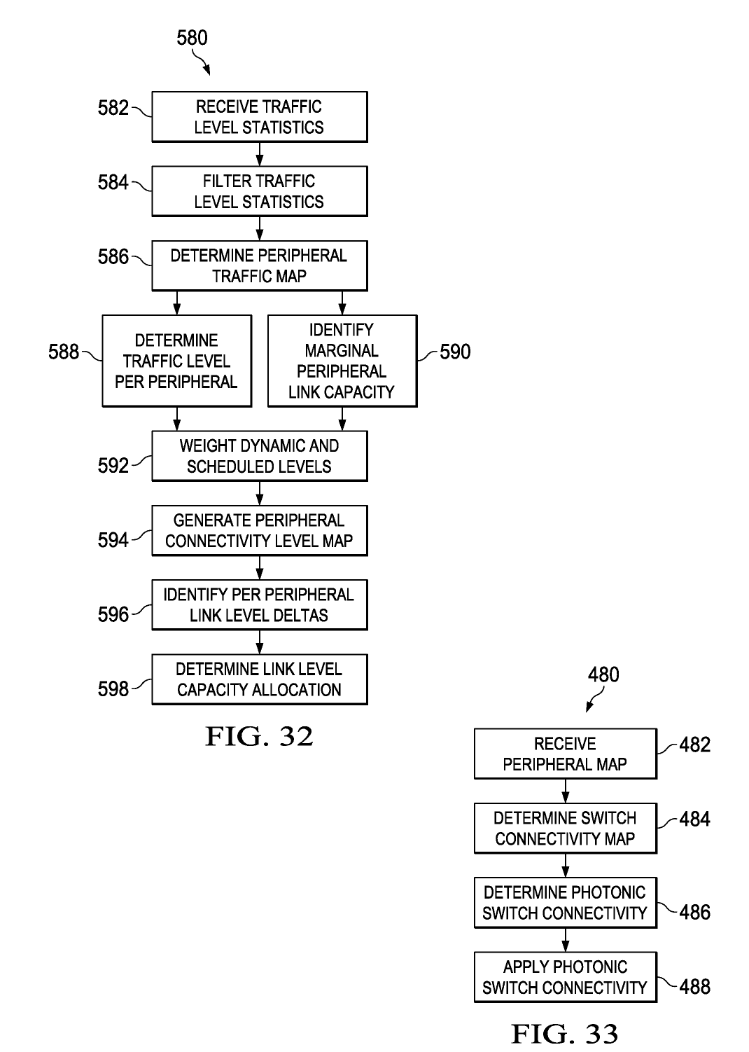

FIG. 32 illustrates flowchart 580 for a method of allocating link capacity in a data center using a photonic switch. This method may be performed by a photonic switch controller. Initially, in step 582, the photonic switch controller receives traffic level statistics. In one example, the traffic level statistics are received by an OMC and passed to the photonic switch controller. In other examples, the traffic level statistics are directly received by the photonic switch controller from the peripherals and the packet switching core.

Next, in step 584, the traffic level statistics are filtered. The filtering reduces the stream of real-time traffic level measurements to the significant data. For example, data may be aggregated and averaged, to produce a rolling view of per peripheral traffic levels. Additional filtering may be performed. The additional filtering may be non-linear, for example based on the significance of an event. For example, a component failure may be responded to more quickly than a gradual increase in traffic.

Then, in step 586, a peripheral traffic map is created based on the filtered traffic level statistics.

Based on the peripheral traffic map, the traffic level per peripheral is determined in step 588. This is the real-time traffic level in the peripherals.

Also, in step 590, marginal peripheral link capacity is determined. The values for links that have a high capacity and a low capacity may be recorded. Alternatively, the values for all links are recorded.

In step 592, whether links are determined based on dynamic factors, scheduled factors, or a combination is determined. The links may be determined entirely based on dynamic traffic measurements, entirely based on scheduled considerations, or a mix of dynamic and scheduled traffic factors.

Next, in step 594, the photonic switch controller generates a peripheral connectivity level map. The peripheral connectivity level map provisions the necessary link resources.

Then, in step 596, the per peripheral link level deltas are determined. In this step, the photonic switch controller determines which links should be changed.

Finally, in step 598, the photonic switch controller determines the link level allocation capacity. This is done by allocating links based on capacity and priority.

FIG. 33 illustrates flowchart 480 for a method of adjusting links in a data center using a photonic switch. This method may be performed by a photonic switch controller. Initially, in step 482, the photonic switch controller receives the peripheral map. This may be the peripheral map created by flowchart 580.

Then, in step 484, the photonic switch controller determines a switch connectivity map. This is done, for example, based on the link level connectivity map.

In step 486, the photonic switch controller determines the peripheral connectivity level. This may be based on the switch connectivity map and the peripheral map.

Finally, in step 488, the photonic switch control adjusts the connections in the photonic switch to reflect the peripheral connectivity level.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

What is claimed is:

1. A data center comprising:
a packet switching core;
a photonic switch comprising
a first plurality of ports optically coupled to the packet switching core, and
a second plurality of ports configured to be optically coupled to a plurality of peripherals, wherein the photonic switch is configured to link packets between the plurality of peripherals and the packet switching core;
a photonic switch controller coupled to the photonic switch; and
an operations and management center coupled between the packet switching core and the photonic switch controller.

2. The data center of claim 1, wherein the photonic switch comprises a micro-electro-mechanical system (MEMS) optical switch.

3. The data center of claim 2, wherein the MEMS optical switch is a multi-stage MEMS switch.

4. The data center of claim 1, wherein the photonic switch controller is configured to control the photonic switch in accordance with a per peripheral time of day or day of week traffic forecast.

5. The data center of claim 1 wherein the photonic switch controller is configured to control the photonic switch in accordance with measured load levels and a number of provisioned links per peripheral.

6. The data center of claim 5, wherein the photonic switch controller is further configured to control the photonic switch in accordance with a time-variant or level-variant hysteresis.

7. The data center of claim 1, wherein the photonic switch comprises:
a first switching fabric configured to link packets from the plurality of peripherals to the packet switching core; and
a second switching fabric configured to link packets from the packet switching core to the plurality of peripherals.

8. The data center of claim 7, wherein the first switching fabric and the second switching fabric are multi-stage MEMS switches.

9. The data center of claim 7, wherein an output port of the first switching fabric is connected to an input port of the second switching fabric, wherein an output of a first peripheral of the plurality of peripherals is coupled to be an input of a second peripheral of the plurality of peripherals.

10. The data center of claim 1, further comprising test equipment coupled to the photonic switch.

11. The data center of claim 1, further comprising a plurality of adaptors coupled to the photonic switch.

12. A method of controlling a photonic switch in a data center, the method comprising:
receiving, by a photonic switch controller from an operations and management center, a condition in a first traffic flow between a first component and a second component, wherein the first traffic flow comprises
a second traffic flow along a first optical link between the first component and the photonic switch, and
a third traffic flow along a second optical link between the photonic switch and the second component to produce a detected traffic flow; and
adjusting, by the photonic switch controller, connections in the photonic switch in accordance with the detected traffic flow comprising adding an added optical link or removing a removed optical link.

13. The method of claim 12, wherein the first component is a peripheral and the second component is a packet switching module.

14. The method of claim 12, wherein the first component is a packet switching core and the second component is a peripheral.

15. The method of claim 12, wherein detecting the condition comprises detecting an excess load on the first optical link, and wherein adjusting connections in the photonic switch comprises adding the added optical link between the first component and the photonic switch.

16. The method of claim 15, further comprising removing the removed optical link between the first component and the photonic switch.

17. The method of claim 12, wherein detecting the condition comprises detecting a failure of the first component, and wherein adjusting connections in the photonic switch comprises adding the added optical link between the photonic switch and a third component, the method further comprising removing the first optical link.

18. The method of claim 12, wherein detecting the condition comprises detecting a failure in the first link, and wherein adjusting connections in the photonic switch comprises adding the added optical link between the photonic switch and a third component, the method further comprising removing the first optical link.

19. The method of claim 12, wherein detecting the condition comprises detecting excess capacity in the first link, and wherein adjusting the photonic switch comprises removing the added optical link, wherein the removed optical link is the first optical link, the method further comprising removing the second optical link.

20. The method of claim 19, further comprising powering down the first component.

21. The method of claim 12, wherein detecting the condition comprises deciding to test the second component, and wherein adjusting the photonic switch comprises removing the removed optical link, wherein the removed optical link is the first optical link, the method further comprising coupling the second component to a test equipment.

22. A method of controlling a photonic switch in a data center, the method comprising:
obtaining a peripheral connectivity level map;
determining a switch connectivity map;
determining a photonic switch connectivity in accordance with the peripheral connectivity level map and the switch connectivity map; and
configuring the photonic switch in accordance with the photonic switch connectivity.

23. The method of claim 22, wherein obtaining the peripheral map comprises determining link levels for a plurality of links.

24. The method of claim 22, wherein obtaining the peripheral connectivity level map comprises:
receiving traffic level statistics from a plurality of peripherals;
determining a time of day level in accordance with the traffic level statistics; and
determining a peripheral traffic map in accordance with the traffic level statistics.

25. The method of claim 22, wherein determining the switch connectivity map is performed in accordance with a link level connectivity map.
